(19) United States
(12) Patent Application Publication
(10) Pub. No.: US 2023/0084010 A1
(43) Pub. Date: Mar. 16, 2023

(54) METHODS AND APPARATUS FOR CONTROLLING GAS FLOW IN GRILLS BASED ON POSITION DATA DETECTED VIA ROTARY ENCODERS

(71) Applicant: Weber-Stephen Products LLC, Palatine, IL (US)

(72) Inventors: Kevin James Glennon, Hoffman Estates, IL (US); José Ángel Martinez, Franklin Park, IL (US); Anthony Zaprzalka, Rolling Meadows, IL (US)

(21) Appl. No.: 17/896,991

(22) Filed: Aug. 26, 2022

Related U.S. Application Data
(60) Provisional application No. 63/284,552, filed on Nov. 30, 2021.
(60) Provisional application No. 63/242,901, filed on Sep. 10, 2021.
(60) Provisional application No. 63/242,864, filed on Sep. 10, 2021.

(51) Int. Cl. F24C 3/12; A47J 37/07; A23L 5/10

(52) U.S. Cl. CPC F24C 3/126; A47J 37/0713; A47J 37/0786; A23L 5/15; A23V 2002/00

(57) ABSTRACT

Example methods and apparatus for controlling gas flow in grills based on position data detected via rotary encoders. An example grill includes a burner valve, a rotary encoder, and a controller. The burner valve is movable between an open position and a closed position. The rotary encoder includes a rotatable portion and a fixed portion. The control knob is mechanically coupled to the rotatable portion. The rotatable portion is rotatable relative to the fixed portion. The rotary encoder is to detect a rotational position of the control knob. The rotational position of the control knob corresponds to a rotational position of the rotatable portion relative to the fixed portion. The controller is in electrical communication with the rotary encoder. The controller is to determine a target position of the burner valve based on the rotational position of the control knob. The controller is to instruct the burner valve to move to the target position.

### RELATED APPLICATIONS

This application claims priority to U.S. Provisional Patent Application No. 63/284,552, filed Nov. 30, 2021, U.S. Provisional Patent Application No. 63/242,901, filed Sep. 10, 2021, and U.S. Provisional Patent Application No. 63/242,864, filed Sep. 10, 2021. The entireties of U.S. Provisional Patent Application No. 63/284,552, U.S. Provisional Patent Application No. 63/242,901, and U.S. Provisional Patent Application No. 63/242,864 are hereby incorporated by reference herein.

### FIELD OF THE DISCLOSURE

This disclosure relates generally to the controlling gas flow in grills and, more specifically, to methods and apparatus for controlling gas flow in grills based on position data detected via rotary encoders.

### BACKGROUND

Gas grills are conventionally equipped with one or more burner(s) (e.g., one or more tube(s) configured to carry combustible gas) located within a cookbox of the grill. A gas train (e.g., implemented via one or more rigid or flexible pipe(s), tube(s), and/or conduit(s)) typically extends from a fuel source (e.g., a propane tank, or a piped (e.g., household) natural gas line) associated with the grill to a manifold of the grill, and from the manifold of the grill to respective ones of the burner(s) of the grill. One or more burner valve(s) (e.g., typically corresponding in number to the number of burner(s) of the grill) is/are coupled to and operatively positioned within the gas train between the manifold and corresponding ones of the burner(s). Each burner valve is configured to be movable between a closed position that prevents gas contained within the manifold from flowing into the corresponding burner, and an open position that enables gas contained within the manifold to flow from the manifold into the corresponding burner.

In known gas grills of the type described above, each burner valve typically has a stem that extends away from the cookbox of the grill and through a control panel of the grill, with the control panel commonly being located along a front side of the cookbox of the grill. For each burner valve, a control knob is mechanically coupled to the stem of the burner valve such that manual rotation of the control knob (e.g., by a user of the grill) mechanically causes a corresponding rotation of the stem of the burner valve. Rotating the stem of the burner valve in turn causes the burner valve to move between its closed position and its open position, thereby affecting the extent and/or the rate at which gas is able to flow from the manifold of the grill, through the burner valve of the grill, and into the corresponding burner of the grill. Such known gas grills accordingly have a mechanical control architecture with regard to the relationship between the position(s) of the one or more control knob(s) of the grill and the flow of gas into the corresponding one or more burner(s) of the grill.

### BRIEF DESCRIPTION OF THE DRAWINGS

FIG. 1 is a block diagram of an example grill constructed in accordance with the teachings of this disclosure.

FIG. 2 is a perspective view of an example implementation of the grill of FIG. 1, with an example lid of the grill shown in an example closed position relative to an example cookbox of the grill.

FIG. 3 is a perspective view of the implementation of the grill shown in FIG. 2, with the lid of the grill shown in an example open position relative to the cookbox of the grill.

FIG. 4 is an exploded view of the implementation of the grill shown in FIGS. 2 and 3.

FIG. 5 is a perspective view of the cookbox of the implementation of the grill shown in FIGS. 2-4.

FIG. 6 is a partial cross-sectional view of the implementation of the grill shown in FIGS. 2-4.

FIG. 7 a front view of an example lighting module that may be implemented as one of the lighting module(s) of FIG. 1.

FIG. 8 is a front view of the lighting module shown in FIG. 7, with the control knob of FIG. 7 removed.

FIG. 9 is a side view of the lighting module shown in FIGS. 7 and 8, with the control knob of FIG. 7 removed.

FIG. 10 is another front view of the lighting module shown in FIGS. 7-9, with the control knob of FIG. 7 removed.

FIG. 11 is a front view of an example user interface that may be implemented as the user interface of FIG. 1.

FIG. 12 is a flowchart representative of example machine-readable instructions and/or example operations that may be executed by processor circuitry to implement a gas flow control process of the grill of FIG. 1.

FIG. 13 is a flowchart representative of example machine-readable instructions and/or example operations that may be executed by processor circuitry to implement a control knob position notification process of the grill of FIG. 1.

FIG. 14 is a flowchart representative of example machine-readable instructions and/or example operations that may be executed by processor circuitry to implement a burner valve position notification process of the grill of FIG. 1.

FIG. 15 is a block diagram of an example processor platform including processor circuitry structured to execute and/or instantiate the machine-readable instructions and/or operations of FIGS. 12-14 to implement the grill of FIG. 1.

FIG. 16 is a block diagram of an example implementation of the processor circuitry of FIG. 15.

FIG. 17 is a block diagram of another example implementation of the processor circuitry of FIG. 15.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Conventional gas grills of the type described above have a mechanical control architecture with regard to the relationship between the position(s) of one or more control knob(s) of the grill and the flow of gas into a corresponding one or more burner(s) of the grill. In this regard, such known gas grills include one or more burner valve(s), each having a stem that extends away from a cookbox of the grill and through a control panel of the grill, with the control panel commonly being located along a front side of the cookbox of the grill. For each burner valve, a control knob is mechanically coupled to the stem of the burner valve such that manual rotation of the control knob (e.g., by a user of the grill) mechanically causes a corresponding rotation of the stem of the burner valve. Rotating the stem of the burner valve in turn causes the burner valve to move between its closed position and its open position, thereby affecting the extent and/or the rate at which gas is able to flow from a manifold of the grill, through the burner valve of the grill, and into a corresponding burner of the grill.

In contrast to conventional gas grills that implement mechanical control architectures of the type described above, the methods and apparatus disclosed herein advantageously provide “control-by-wire” architectures for gas grills that eliminate the above-described mechanical connection which conventionally exists between each control knob of the grill and each corresponding burner valve of the grill. In some examples, gas grills disclosed herein include a burner valve, a control knob, a rotary encoder, and a controller. The burner valve is movable between an open position and a closed position. The rotary encoder includes a rotatable portion and a fixed portion. The control knob is mechanically coupled to the rotatable portion of the rotary encoder, which is rotatable relative to the fixed portion of the rotary encoder. No mechanical connection exists, however, between the control knob and the burner valve.

In this regard, the rotary encoder is configured to detect a rotational position of the control knob. The rotational position of the control knob corresponds to a rotational position of the rotatable portion of the rotary encoder relative to the fixed portion of the rotary encoder. The controller is in electrical communication with the rotary encoder. The controller is also in electrical communication with the burner valve, which is implemented as a controllable electric valve (e.g., a solenoid valve). The controller is configured to determine a target position of the burner valve based on the rotational position of the control knob. The controller is further configured to instruct the burner valve to move to the target position, thereby implementing a “control-by-wire” architecture with regard to the relationship between the position(s) of the one or more control knob(s) of the grill and the flow of gas into the corresponding one or more burner(s) of the grill.

In some examples, the controller is further configured to instruct a lighting module of the grill to present a notification indicating at least one of the rotational position of the control knob or the target position of the burner valve. In some such examples, the lighting module includes a light source, and presenting the notification includes illuminating the light source. In other such examples, the lighting module includes a light source, and presenting the notification includes pulsing the light source. In some examples, the controller is further configured to instruct one or more output devices of a user interface of the grill to present a notification indicating at least one of the rotational position of the control knob or the target position of the burner valve. In some examples, the controller is further configured to instruct a notification indicating at least one of the rotational position of the control knob or the target position of the burner valve to be presented at a remote device in electrical communication with the grill.

The above-identified features as well as other advantageous features of example methods and apparatus for controlling gas flow in grills based on position data detected via rotary encoders as disclosed herein are further described below in connection with the figures of the application. As used herein in a mechanical context, the term “configured” means sized, shaped, arranged, structured, oriented, positioned, and/or located. For example, in the context of a first object configured to fit within a second object, the first object is sized, shaped, arranged, structured, oriented, positioned, and/or located to fit within the second object. As used herein in an electrical and/or computing context, the term “configured” means arranged, structured, and/or programmed. For example, in the context of a controller configured to perform a specified operation, the controller is arranged, structured, and/or programmed (e.g., based on machine-readable instructions) to perform the specified operation. As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, the term “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

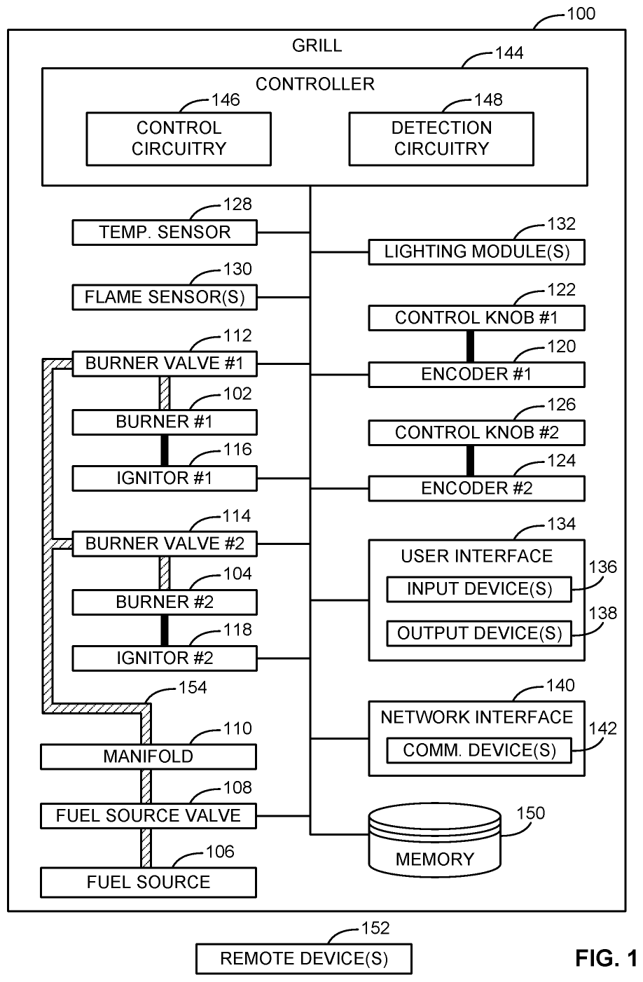

FIG. 1 is a block diagram of an example grill 100 constructed in accordance with the teachings of this disclosure. The grill 100 of FIG. 1 is a gas grill including a plurality of burners. In other examples, the grill 100 can be implemented as a different type of grill having a controllable heat source (e.g., a pellet grill, an electric grill, etc.). In the illustrated example of FIG. 1, the grill 100 includes an example first burner 102 and an example second burner 104. In other examples, the grill 100 can include one or more other burner(s) (e.g., a third burner, a fourth burner, a fifth burner, etc.) in addition to the first burner 102 and the second burner 104 shown and described in connection with FIG. 1. The first burner 102 and the second burner 104 of FIG. 1 are each constructed as a burner tube (e.g., a linear burner tube) including a gas inlet for receiving a flow of combustible gas, and further including a plurality of apertures configured to emit flames generated in response to ignition of the gas flowing into and/or through the burner tube.

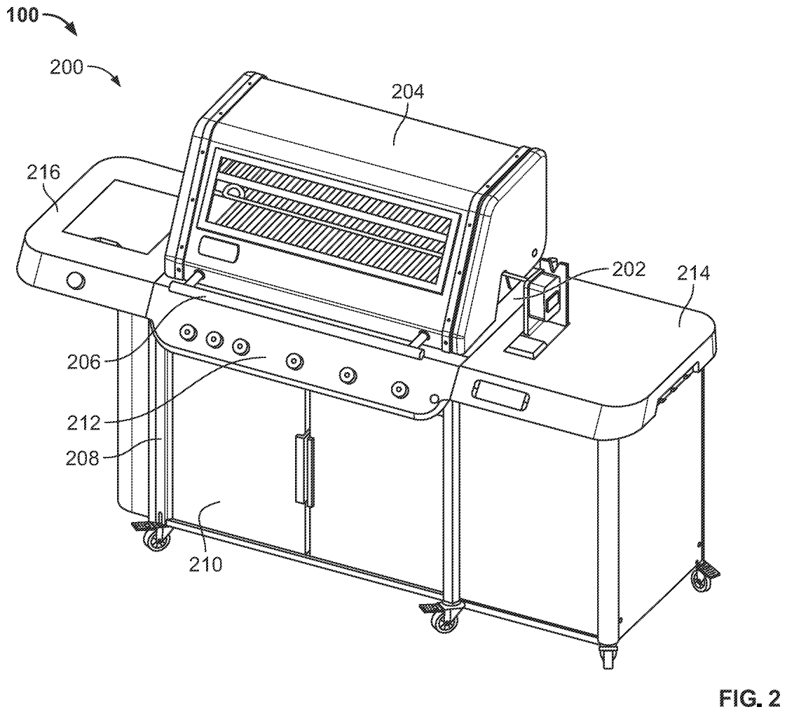

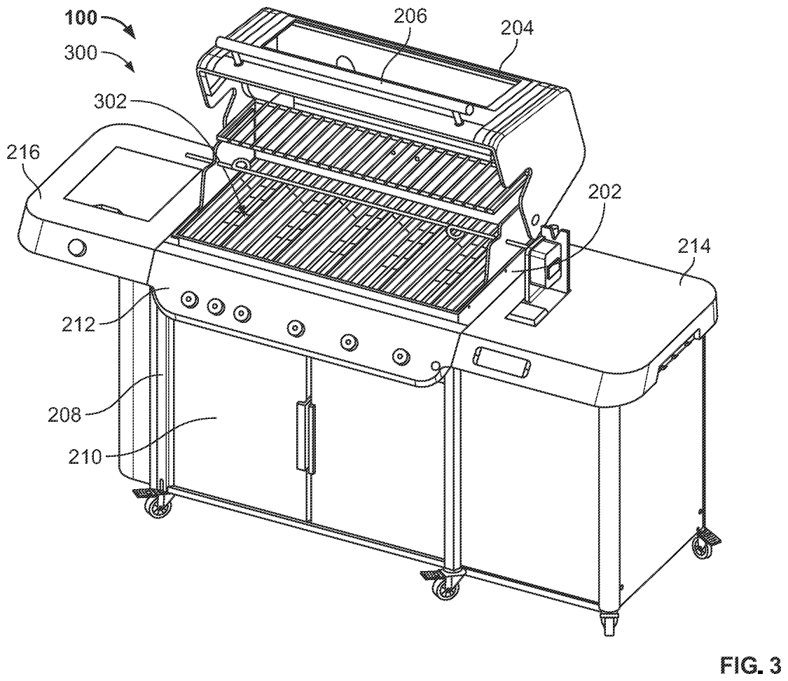

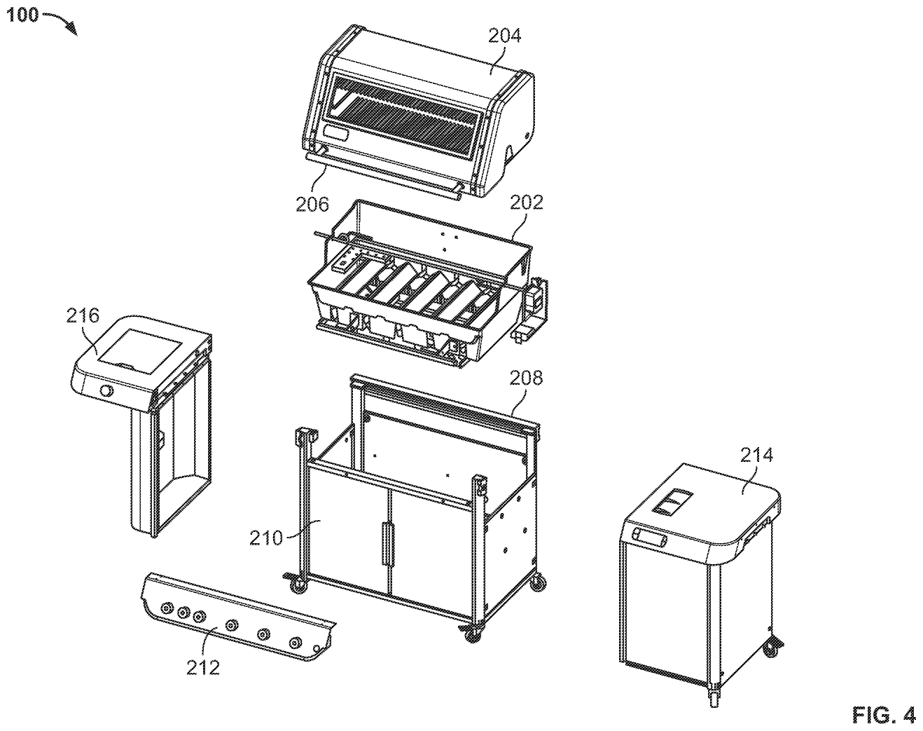

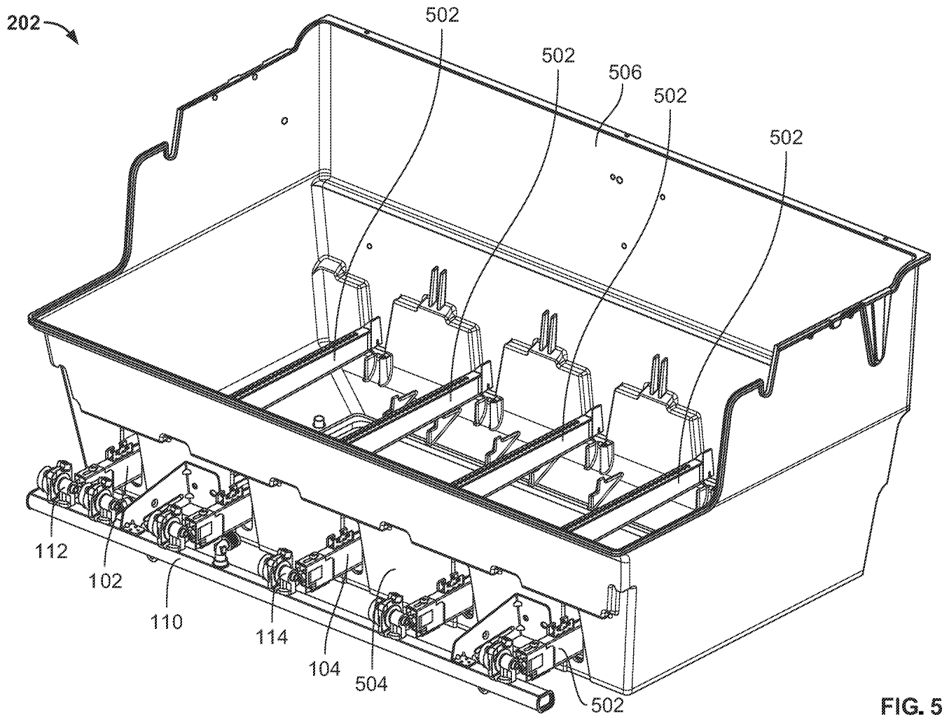

FIG. 2 is a perspective view of an example implementation of the grill 100 of FIG. 1, with an example lid 204 of the grill 100 shown in an example closed position 200 relative to an example cookbox 202 of the grill 100. FIG. 3 is a perspective view of the implementation of the grill 100 shown in FIG. 2, with the lid 204 of the grill 100 shown in an example open position 300 relative to the cookbox 202 of the grill 100. FIG. 4 is an exploded view of the implementation of the grill 100 shown in FIGS. 2 and 3. FIG. 5 is a perspective view of the cookbox 202 of the implementation of the grill 100 shown in FIGS. 2-4.

The cookbox 202 of the grill 100 supports, carries, and/or houses the burners (e.g., the first burner 102 and the second burner 104) of the grill 100, with respective ones of the burners being spaced apart from one another within the cookbox 202. As shown in FIG. 5, the cookbox 202 supports, carries, and/or houses a total of five example burners 502 (e.g., including the first burner 102 and the second burner 104 of FIG. 1), with each of the five burners 502 being spaced apart from one another within the cookbox 202. In other examples, the cookbox 202 can support, carry, and/or house a different number (e.g., two, three, four, six, etc.) of burners 502. In the illustrated example of FIGS. 2-5, each of the burners 502 is constructed as a linear burner tube positioned in a front-to-rear orientation within the cookbox 202 (e.g., extending from a front wall 504 of the cookbox 202 to a rear wall 506 of the cookbox 202). In other examples, one or more of the burner(s) 502 can have a different shape (e.g., a non-linear shape such as a P-tube), and/or can have a different orientation (e.g., a left-to-right orientation) within the cookbox 202. It should accordingly be understood that the cookbox configuration shown in FIGS. 2-5 is but one example of a cookbox 202 that can be implemented as part of the grill 100 of FIG. 1.

The lid 204 of the grill 100 is configured to cover and/or enclose the cookbox 202 of the grill 100 when the lid is in a closed position (e.g., the closed position 200 of FIG. 2). In the illustrated example of FIGS. 2-4, the lid 204 is movably (e.g., pivotally) coupled to the cookbox 202 such that the lid 204 can be moved (e.g., pivoted) relative to the cookbox 202 between a closed position (e.g., the closed position 200 of FIG. 2) and an open position (e.g., the open position 300 of FIG. 3). In other examples, the lid 204 of the grill 100 can instead be removably positioned on the cookbox 202 of the grill 100 without there being any direct mechanical coupling between the lid 204 and the cookbox 202. In some such other examples, the lid 204 can be movably (e.g., pivotally) coupled to one or more structure(s) of the grill 100 other than the cookbox 202. For example, the lid 204 can be movably (e.g., pivotally) coupled to a frame, to a cabinet, and/or to one or more side table(s) of the grill 100. Movement of the lid 204 of the grill 100 between the closed position 200 shown in FIG. 2 and the open position 300 shown in FIG. 3 can be facilitated via user interaction with an example handle 206 of the grill 100 that is coupled to the lid 204.

In the illustrated example of FIGS. 2-4, the cookbox 202 and the lid 204 of the grill 100 collectively define an example cooking chamber 302 configured to cook one or more item(s) of food. The cooking chamber 302 of the grill 100 becomes accessible to a user of the grill 100 when the lid 204 of the grill 100 is in the open position 300 shown in FIG. 3. Conversely, the cooking chamber 302 of the grill 100 is generally inaccessible to the user of the grill 100 when the lid 204 of the grill 100 is in the closed position 200 shown in FIG. 2. User access to the cooking chamber 302 of the grill 100 may periodically become necessary, for example, to add an item of food to the cooking chamber 302 (e.g., at or toward the beginning of a cook), to remove an item of food from the cooking chamber 302 (e.g., at or toward the end of a cook), and/or to flip, rotate, relocate, or otherwise move an item of food within the cooking chamber 302 (e.g., during the middle of a cook).

As further shown in FIGS. 2-4, the grill 100 includes an example frame 208 that supports the cookbox 202 of the grill 100. In the illustrated example of FIGS. 2-4, the frame 208 forms an example cabinet 210 within which one or more component(s) of the grill 100 can be housed and/or stored. In other examples, the cabinet 210 of the grill 100 can be omitted in favor of an open-space configuration of the frame 208. As further shown in FIGS. 2-4, the grill 100 includes an example control panel 212 located along the front portion of the cookbox 202, the frame 208, and/or the cabinet 210 of the grill 100, an example first side table 214 located on a first side (e.g., a right side) of the cookbox 202, the frame 208, and/or the cabinet 210 of the grill 100, and an example second side table 216 located on a second side (e.g., a left side) of the cookbox 202, the frame 208, and/or the cabinet 210 of the grill 100. Various components of the grill 100 of FIG. 1 described herein can be supported by, carried by, housed by, mounted to, and/or otherwise coupled to at least one of the cookbox 202, the lid 204, the handle 206, the frame 208, the cabinet 210, the control panel 212, the first side table 214, and/or the second side table 216 of the grill 100.

Returning to the illustrated example of FIG. 1, the grill 100 of FIG. 1 further includes an example fuel source 106, an example fuel source valve 108, an example manifold 110, an example first burner valve 112, an example second burner valve 114, an example first ignitor 116, an example second ignitor 118, an example first encoder 120, an example first control knob 122, an example second encoder 124, an example second control knob 126, an example temperature sensor 128, one or more example flame sensor(s) 130, one or more example lighting module(s) 132, an example user interface 134 (e.g., including one or more example input device(s) 136 and one or more example output device(s) 138), an example network interface 140 (e.g., including one or more example communication device(s) 142), an example controller 144 (e.g., including example control circuitry 146 and example detection circuitry 148), and an example memory 150. The grill 100 of FIG. 1 is configured to communicate (e.g., wirelessly communicate) with one or more example remote device(s) 152, as further described below.

The grill 100 of FIG. 1 includes a control system for controlling, managing, performing, and/or otherwise carrying out one or more operation(s) of the grill 100 including, for example, controlling a flow of gas to the first burner 102 and/or the second burner 104 of the grill 100. In the illustrated example of FIG. 1, the control system of the grill 100 includes the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146 and the detection circuitry 148), and the memory 150. In other examples, one or more of the aforementioned components of the grill 100 can be omitted from the control system of the grill 100. For example, the fuel source valve 108 can be omitted from the control system of the grill 100 in instances where the fuel source valve 108 is not configured to be electrically controlled and/or electrically actuated by the controller 144, with the fuel source valve 108 instead being configured only for manual control and/or manual actuation. In still other examples, the control system of the grill 100 can further include the remote device(s) 152 that are configured to communicate (e.g., wirelessly communicate) with the grill 100.

The control system of the grill 100 of FIG. 1 is powered and/or operated by a power source. For example, the electrical components that form the control system of the grill 100 can be powered and/or operated by DC power supplied via one or more on-board or connected batteries of the grill 100. As another example, the electrical components that form the control system of the grill 100 can alternatively be powered and/or operated by AC power supplied via household electricity or wall power to which the grill 100 is connected. The grill 100 includes a power button (e.g., a power switch) that is configured to enable (e.g., power on) or disable (e.g., power off) the control system of the grill 100 in response to the power button being manually actuated by a user of the grill 100.

The grill 100 of FIG. 1 further includes an example gas train 154 that extends from the fuel source 106 to the manifold 110 of the grill 100, and from the manifold 110 to respective ones of the first burner 102 and the second burner 104 of the grill 100. The gas train 154 can be implemented via one ore more conduit(s) (e.g., one or more rigid or flexible pipe(s), tube(s), etc.) that are configured to carry combustible gas from the fuel source 106 to the first burner 102 and/or the second burner 104 of the grill 100. In some examples, the fuel source 106 is implemented as a fuel tank (e.g., a propane tank) containing combustible gas. In such examples, the fuel source 106 will typically be located partially or fully within the cabinet 210 of the grill 100, partially or fully within a spatial footprint formed by the frame 208 of the grill 100, below the cookbox 202 of the grill 100 and partially or fully within a spatial footprint formed by the cookbox 202 of the grill 100, or below the cookbox 202 of the grill 100 and partially or fully within a spatial footprint formed by the first side table 214 or the second side table 216 of the grill 100. In other examples, the fuel source 106 can instead be implemented as a piped (e.g., household) natural gas line that provides an accessible flow of combustible gas.

The fuel source valve 108 of FIG. 1 is coupled to and operatively positioned within the gas train 154 between the fuel source 106 and the manifold 110 of the grill 100. The fuel source valve 108 is configured to be movable between a closed position that prevents gas contained within the fuel source 106 from flowing into the manifold 110, and an open position that enables gas contained within the fuel source 106 to flow from the fuel source 106 into the manifold 110. In the illustrated example of FIG. 1, the fuel source valve 108 is operatively coupled to (e.g., in electrical communication with) the controller 144 of the grill 100, with the fuel source valve 108 being implemented as a controllable electric valve (e.g., a solenoid valve) that is configured to transition from the closed position to the open position, and vice-versa, in response to instructions, commands, and/or signals (e.g., a supply of current) generated by the controller 144. In other examples, the fuel source valve 108 can instead be implemented as a valve having a knob or a lever operatively coupled (e.g., mechanically coupled) thereto, with the knob or the lever being configured to be electrically actuated (e.g., via a motor) in response to instructions, commands, and/or signals generated by the controller 144 of the grill 100. In still other examples, the fuel source valve 108 may have no electrically-controllable components, in which case actuation of the fuel source valve 108 from the closed position to the open position, and vice-versa, occurs in response to a user of the grill 100 manually actuating a knob or a lever that is operatively coupled (e.g., mechanically coupled) to the fuel source valve 108.

The first burner valve 112 of FIG. 1 is coupled to and operatively positioned within the gas train 154 between the manifold 110 and the first burner 102 of the grill 100. In some examples, a gas inlet of the first burner valve 112 is located within the manifold 110, and a gas outlet of the first burner valve 112 is located within the first burner 102. The first burner valve 112 is configured to be movable between a closed position that prevents gas contained within the manifold 110 from flowing into the first burner 102, and an open position that enables gas contained within the manifold 110 to flow from the manifold 110 into the first burner 102. In the illustrated example of FIG. 1, the first burner valve 112 is operatively coupled to (e.g., in electrical communication with) the controller 144 of the grill 100, with the first burner valve 112 being is implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the first burner valve 112 is controllable to any position (e.g., infinite position control) between the above-described closed position (e.g., fully closed) and the above-described open position (e.g., fully open). In such examples, the first burner valve 112 of FIG. 1 may be controlled to various positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

The second burner valve 114 of FIG. 1 is coupled to and operatively positioned within the gas train 154 between the manifold 110 and the second burner 104 of the grill 100. In some examples, a gas inlet of the second burner valve 114 is located within the manifold 110, and a gas outlet of the second burner valve 114 is located within the second burner 104. The second burner valve 114 is configured to be movable between a closed position that prevents gas contained within the manifold 110 from flowing into the second burner 104, and an open position that enables gas contained within the manifold 110 to flow from the manifold 110 into the second burner 104. In the illustrated example of FIG. 1, the second burner valve 114 is operatively coupled to (e.g., in electrical communication with) the controller 144 of the grill 100, with the second burner valve 114 being implemented as a controllable electric valve (e.g., a solenoid valve) that is configured to transition from the closed position to the open position, and vice-versa, in response to instructions, commands, and/or signals (e.g., a supply of current) generated by the controller 144. In some examples, the second burner valve 114 is controllable to any position (e.g., infinite position control) between the above-described closed position (e.g., fully closed) and the above-described open position (e.g., fully open). In such examples, the second burner valve 114 of FIG. 1 may be controlled to various positions to achieve different specified temperatures (e.g., different setpoint temperatures) within the cooking chamber 302 of the grill 100, as may be required by the various ordered steps, instructions, and/or operations of one or more selectable cook program(s) to be implemented via the control system of the grill 100.

As described above, the first burner valve 112 and the second burner valve 114 of FIG. 1 respectively differ from known burner valves of conventional gas grills in that neither the first burner valve 112 nor the second burner valve 114 includes a stem that is mechanically coupled to a user-accessible control knob of the grill, whereby the control knob traditionally facilitates manual control and/or manual actuation of the operable position of the burner valve. The first burner valve 112 and the second burner valve 114 of FIG. 1 are instead only controllable and/or actuatable via the “control-by-wire” functionality further described herein.

The first ignitor 116 of FIG. 1 is mechanically coupled and/or operatively positioned relative to the first burner 102 of the grill 100. More specifically, the first ignitor 116 is located adjacent the first burner 102 at a position that enables the first ignitor 116 to ignite combustible gas as the gas emanates from within the first burner 102 via apertures formed in the first burner 102. The first ignitor 116 of FIG. 1 is operatively coupled to (e.g., in electrical communication with) the controller 144 of the grill 100, with the first ignitor 116 being configured to generate sparks (e.g., via a spark electrode of the first ignitor 116) and/or otherwise induces ignition of the combustible gas in response to an instruction, a command, and/or a signal generated by the controller 144.

The second ignitor 118 of FIG. 1 is mechanically coupled and/or operatively positioned relative to the second burner 104 of the grill 100. More specifically, the second ignitor 118 is located adjacent the second burner 104 at a position that enables the second ignitor 118 to ignite combustible gas as the gas emanates from within the second burner 104 via apertures formed in the second burner 104. The second ignitor 118 of FIG. 1 is operatively coupled to (e.g., in electrical communication with) the controller 144 of the grill 100, with the second ignitor 118 being configured to generate sparks (e.g., via a spark electrode of the second ignitor 118) and/or otherwise induces ignition of the combustible gas in response to an instruction, a command, and/or a signal generated by the controller 144.

In some examples, the first ignitor 116 and/or the second ignitor 118 of FIG. 1 can respectively be structured, configured, and/or implemented as one of the various ignitors described in U.S. patent application Ser. No. 17/144,038, filed on Jan. 7, 2021. In such examples, the first ignitor 116 and/or the second ignitor 118 of FIG. 1 can respectively be mechanically coupled to a corresponding one of the first burner 102 and/or the second burner 104 of the grill 100 via a ceramic harness as described in U.S. patent application Ser. No. 17/144,038. The entirety of U.S. patent application Ser. No. 17/144,038 is hereby incorporated by reference herein.

The first encoder 120 of FIG. 1 is mechanically coupled to the first control knob 122 of FIG. 1 and operatively coupled to (e.g., in electrical communication with) the controller 144 of FIG. 1. In this regard, the first encoder 120 of FIG. 1 is implemented as a rotary encoder having a rotatable portion (e.g., a rotatable shaft) to which the first control knob 122 is mechanically coupled. The rotatable portion of the first encoder 120 can be rotated relative to a fixed portion of the first encoder 120 via user interaction with the first control knob 122 (e.g., manual rotation of the first control knob 122). The fixed portion of the first encoder 120 includes one or more sensor(s) that is/are configured to sense, measure, and/or detect the relative angular position of the rotatable portion and/or the relative angular position of the first control knob 122. Data, information, and/or signals that is/are sensed, measured, and/or detected by the sensor(s) of the first encoder 120 can be transmitted directly to the controller 144 of FIG. 1, and/or can be transmitted to and stored in the memory 150 of FIG. 1. In some examples, the sensor(s) of the first encoder 120 is/are further configured to sense, measure, and/or detect a translational movement of the rotatable portion relative to the fixed portion of the first encoder 120, as may occur in response to a user of the grill 100 pushing or pressing on the first control knob 122 in a direction that is generally perpendicular to the direction(s) in which the first control knob 122 is configured to be rotated by the user.

In some examples, the first encoder 120 of FIG. 1 is mounted to the control panel 212 of the grill 100 (e.g., to a printed circuit board of the control panel 212) such that the first encoder 120 is located at a position on the control panel 212 that would conventionally be occupied by a stem of a burner valve that corresponds to the first burner valve 112 of FIG. 1. Such an example further facilitates locating the first control knob 122 of FIG. 1 at a position on or along the control panel 212 that would conventionally be occupied by a control knob that is mechanically coupled to the stem of the burner valve that corresponds to the first burner valve 112 of FIG. 1. While the first control knob 122 of FIG. 1 may accordingly be located at a position on or along the control panel 212 of the grill 100 that mimics the position at which a traditional control knob is located, user actuation (e.g., manual rotation) of the first control knob 122 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the first control knob 122 of FIG. 1 and the first encoder 120 of FIG. 1, (2) a first electrical connection existing between the first encoder 120 of FIG. 1 and the controller 144 and/or the memory 150 of FIG. 1, and (3) a second electrical connection existing between the controller 144 of FIG. 1 and the first burner valve 112 of FIG. 1.

Although the first control knob 122 of FIG. 1 is not mechanically coupled to the first burner valve 112 of FIG. 1, rotation of the first control knob 122 by a user of the grill 100 can nonetheless cause the first burner valve 112 to open, close, or otherwise adjust its position. In this regard, the controller 144 of FIG. 1 is configured to interpret different rotational positions of the first control knob 122 of FIG. 1 (e.g., as sensed, measured, and/or detected by the first encoder 120 of FIG. 1) as being indicative of correlated user requests associated with different operational states (e.g., ignite, high, medium, low, or off) of the first burner 102 of FIG. 1. For example, in response to determining that the first control knob 122 has been positioned at a relative angle of negative one hundred eighty degrees (−180°), the controller 144 may interpret the determined rotational position as a user request that the first burner 102 operate in a “medium” state. To satisfy the user request indicated by the determined rotational position of the first control knob 122, the controller 144 may instruct, command, and/or signal the first burner valve 112 of FIG. 1 to assume a first corresponding target position, such as a partially open (e.g., 50% open) position that facilitates a “medium” flow of gas through the first burner valve 112 and into the first burner 102, thereby effecting the “medium” operational state of the first burner 102.

As another example, in response to determining that the first control knob 122 has been positioned at a relative angle of negative ninety degrees (−90°), the controller 144 may interpret the determined rotational position as a user request that the first burner 102 operate in a “high” state. To satisfy the user request indicated by the determined rotational position of the first control knob 122, the controller 144 may instruct, command, and/or signal the first burner valve 112 of FIG. 1 to assume a second corresponding target position, such as a fully open (e.g., 100% open) position that facilitates a “high” flow of gas through the first burner valve 112 and into the first burner 102, thereby effecting the “high” operational state of the first burner 102. As yet another example, in response to determining that the first control knob 122 has been positioned at a relative angle of zero degrees (0°), the controller 144 may interpret the determined rotational position as a user request that the first burner 102 be placed in an “off” state. To satisfy the user request indicated by the determined rotational position of the first control knob 122, the controller 144 may instruct, command, and/or signal the first burner valve 112 of FIG. 1 to assume a third corresponding target position, such as a fully closed (e.g., 0% open, or 100% closed) position that prevents any flow of gas through the first burner valve 112 and into the first burner 102, thereby effecting the “off” state of the first burner 102.

As yet another example, in response to determining that the first control knob 122 has been pushed and/or pressed inward, the controller 144 may interpret the determined translational position as a user request that the first burner 102 be ignited. To satisfy the user request indicated by the determined translational position of the first control knob 122, the controller 144 may instruct, command, and/or signal the first burner valve 112 of FIG. 1 to assume a fully open (e.g., 100% open) position that facilitates a “high” flow of gas through the first burner valve 112 and into the first burner 102. The controller 144 may further instruct, command, and/or signal the first ignitor 116 of FIG. 1 to ignite the flow of gas emanating from the first burner 102, thereby effecting the “ignited” state of the first burner 102. As yet another example, in response to determining that the first control knob 122 has been pushed and/or pressed inward, the controller 144 may interpret the determined translational position as a user request that all burners (e.g., the first burner 102 and the second burner 104) of the grill 100 be ignited. To satisfy the user request indicated by the determined translational rotational position of the first control knob 122, the controller 144 may instruct, command, and/or signal the first burner valve 112 and the second burner valve 114 of FIG. 1 to respectively assume (e.g., either concurrently, or sequentially) a fully open (e.g., 100% open) position that facilitates a “high” flow of gas through the first burner valve 112 and into the first burner 102, as well as a “high” flow of gas through the second burner valve 114 and into the second burner 104. The controller 144 may further instruct, command, and/or signal the first ignitor 116 and the second ignitor 118 of FIG. 1 to respectively ignite (e.g., either concurrently or sequentially) the flow of gas emanating from the first burner 102 and the flow of gas emanating from the second burner 104, thereby effecting the “ignited” state of both the first burner 102 and the second burner 104.

Correlation data (e.g., a correlation table) establishing and/or defining one or more correlation(s) and/or relationship(s) between one or more position(s) (e.g., one or more rotational and/or translational position(s)) of the first encoder 120 and/or the first control knob 122 of the grill 100 of FIG. 1 on the one hand, and one or more position(s) (e.g., one or more target position(s)) of the first burner valve 112 of the grill of FIG. 1 on the other hand may be stored in the memory 150 of the grill 100 of FIG. 1. Such correlation data may be accessed from the memory 150 by the controller 144 of the grill 100 of FIG. 1 in the course of the controller 144 determining a target position for the first burner valve 112 (e.g., a position to which the controller 144 is to instruct, command, and/or otherwise cause the first burner valve 112 to move to) based on a detected and/or determined position (e.g., a rotational and/or a translational position) of the first encoder 120 and/or the first control knob 122 of the grill 100 of FIG. 1, as further described below.

The second encoder 124 of FIG. 1 is mechanically coupled to the second control knob 126 of FIG. 1 and operatively coupled to (e.g., in electrical communication with) the controller 144 of FIG. 1. In this regard, the second encoder 124 of FIG. 1 is implemented as a rotary encoder having a rotatable portion (e.g., a rotatable shaft) to which the second control knob 126 is mechanically coupled. The rotatable portion of the second encoder 124 can be rotated relative to a fixed portion of the second encoder 124 via user interaction with the second control knob 126 (e.g., manual rotation of the second control knob 126). The fixed portion of the second encoder 124 includes one or more sensor(s) that is/are configured to sense, measure, and/or detect the relative angular position of the rotatable portion and/or the relative angular position of the second control knob 126. Data, information, and/or signals that is/are sensed, measured, and/or detected by the sensor(s) of the second encoder 124 can be transmitted directly to the controller 144 of FIG. 1, and/or can be transmitted to and stored in the memory 150 of FIG. 1. In some examples, the sensor(s) of the second encoder 124 is/are further configured to sense, measure, and/or detect a translational movement of the rotatable portion relative to the fixed portion of the second encoder 124, as may occur in response to a user of the grill 100 pushing or pressing on the second control knob 126 in a direction that is generally perpendicular to the direction(s) in which the second control knob 126 is configured to be rotated by the user.

In some examples, the second encoder 124 of FIG. 1 is mounted to the control panel 212 of the grill 100 (e.g., to a printed circuit board of the control panel 212) such that the second encoder 124 is located at a position on the control panel 212 that would conventionally be occupied by a stem of a burner valve that corresponds to the second burner valve 114 of FIG. 1. Such an example further facilitates locating the second control knob 126 of FIG. 1 at a position on or along the control panel 212 that would conventionally be occupied by a control knob that is mechanically coupled to the stem of the burner valve that corresponds to the second burner valve 114 of FIG. 1. While the second control knob 126 of FIG. 1 may accordingly be located at a position on or along the control panel 212 of the grill 100 that mimics the position at which a traditional control knob is located, user actuation (e.g., manual rotation) of the second control knob 126 of FIG. 1 provides a response that differs greatly from that provided by user actuation (e.g., manual rotation) of a traditional control knob.

For example, conventional multi-burner gas grills typically include a plurality of control knobs (e.g., located on or along a control panel of the grill), with each control knob being physically associated with a corresponding one of the burners of the gas grill by virtue of (1) a first mechanical connection existing between the control knob and a stem of a corresponding burner valve (e.g., such that rotation of the control knob by a user of the grill opens, closes, or otherwise adjusts the position of the burner valve), and (2) a second mechanical connection existing between the burner valve and the corresponding burner. By contrast, the grill 100 of FIG. 1 implements a “control-by-wire” architecture that eliminates the first of the aforementioned mechanical connections in favor of (1) a mechanical connection existing between the second control knob 126 of FIG. 1 and the second encoder 124 of FIG. 1, (2) a first electrical connection existing between the second encoder 124 of FIG. 1 and the controller 144 and/or the memory 150 of FIG. 1, and (3) a second electrical connection existing between the controller 144 of FIG. 1 and the second burner valve 114 of FIG. 1.

Although the second control knob 126 of FIG. 1 is not mechanically coupled to the second burner valve 114 of FIG. 1, rotation of the second control knob 126 by a user of the grill 100 can nonetheless cause the second burner valve 114 to open, close, or otherwise adjust its position. In this regard, the controller 144 of FIG. 1 is configured to interpret different rotational positions of the second control knob 126 of FIG. 1 (e.g., as sensed, measured, and/or detected by the second encoder 124 of FIG. 1) as being indicative of correlated user requests associated with different operational states (e.g., ignite, high, medium, low, or off) of the second burner 104 of FIG. 1. For example, in response to determining that the second control knob 126 has been positioned at a relative angle of negative one hundred eighty degrees (−180°), the controller 144 may interpret the determined rotational position as a user request that the second burner 104 operate in a “medium” state. To satisfy the user request indicated by the determined rotational position of the second control knob 126, the controller 144 may instruct, command, and/or signal the second burner valve 114 of FIG. 1 to assume a first corresponding target position, such as a partially open (e.g., 50% open) position that facilitates a “medium” flow of gas through the second burner valve 114 and into the second burner 104, thereby effecting the “medium” operational state of the second burner 104.

As another example, in response to determining that the second control knob 126 has been positioned at a relative angle of negative ninety degrees (−90°), the controller 144 may interpret the determined rotational position as a user request that the second burner 104 operate in a “high” state. To satisfy the user request indicated by the determined rotational position of the second control knob 126, the controller 144 may instruct, command, and/or signal the second burner valve 114 of FIG. 1 to assume a second corresponding target position, such as a fully open (e.g., 100% open) position that facilitates a “high” flow of gas through the second burner valve 114 and into the second burner 104, thereby effecting the “high” operational state of the second burner 104. As yet another example, in response to determining that the second control knob 126 has been positioned at a relative angle of zero degrees (0°), the controller 144 may interpret the determined rotational position as a user request that the second burner 104 be placed in an “off” state. To satisfy the user request indicated by the determined rotational position of the second control knob 126, the controller 144 may instruct, command, and/or signal the second burner valve 114 of FIG. 1 to assume a third corresponding target position, such as a fully closed (e.g., 0% open, or 100% closed) position that prevents any flow of gas through the second burner valve 114 and into the second burner 104, thereby effecting the “off” state of the second burner 104.

As yet another example, in response to determining that the second control knob 126 has been pushed and/or pressed inward, the controller 144 may interpret the determined translational position as a user request that the second burner 104 be ignited. To satisfy the user request indicated by the determined translational position of the second control knob 126, the controller 144 may instruct, command, and/or signal the second burner valve 114 of FIG. 1 to assume a fully open (e.g., 100% open) position that facilitates a “high” flow of gas through the second burner valve 114 and into the second burner 104. The controller 144 may further instruct, command, and/or signal the second ignitor 118 of FIG. 1 to ignite the flow of gas emanating from the second burner 104, thereby effecting the “ignited” state of the second burner. As yet another example, in response to determining that the second control knob 126 has been pushed and/or pressed inward, the controller 144 may interpret the determined translational position as a user request that all burners (e.g., the first burner 102 and the second burner 104) of the grill 100 be ignited. To satisfy the user request indicated by the determined translational position of the second control knob 126, the controller 144 may instruct, command, and/or signal the first burner valve 112 and the second burner valve 114 of FIG. 1 to respectively assume (e.g., either concurrently, or sequentially) a fully open (e.g., 100% open) position that facilitates a “high” flow of gas through the first burner valve 112 and into the first burner 102, as well as a “high” flow of gas through the second burner valve 114 and into the second burner 104. The controller 144 may further instruct, command, and/or signal the first ignitor 116 and the second ignitor 118 of FIG. 1 to respectively ignite (e.g., either concurrently or sequentially) the flow of gas emanating from the first burner 102 and the flow of gas emanating from the second burner 104, thereby effecting the “ignited” state of both the first burner 102 and the second burner 104.

Correlation data (e.g., a correlation table) establishing and/or defining one or more correlation(s) and/or relationship(s) between one or more position(s) (e.g., one or more rotational and/or translational position(s)) of the second encoder 124 and/or the second control knob 126 of the grill 100 of FIG. 1 on the one hand, and one or more position(s) (e.g., one or more target position(s)) of the second burner valve 114 of the grill 100 of FIG. 1 on the other hand may be stored in the memory 150 of the grill 100 of FIG. 1. Such correlation data may be accessed from the memory 150 by the controller 144 of the grill 100 of FIG. 1 in the course of the controller 144 determining a target position for the second burner valve 114 (e.g., a position to which the controller 144 is to instruct, command, and/or otherwise cause the second burner valve 114 to move to) based on a detected and/or determined position (e.g., a rotational and/or a translational position) of the second encoder 124 and/or the second control knob 126 of the grill 100 of FIG. 1, as further described below.

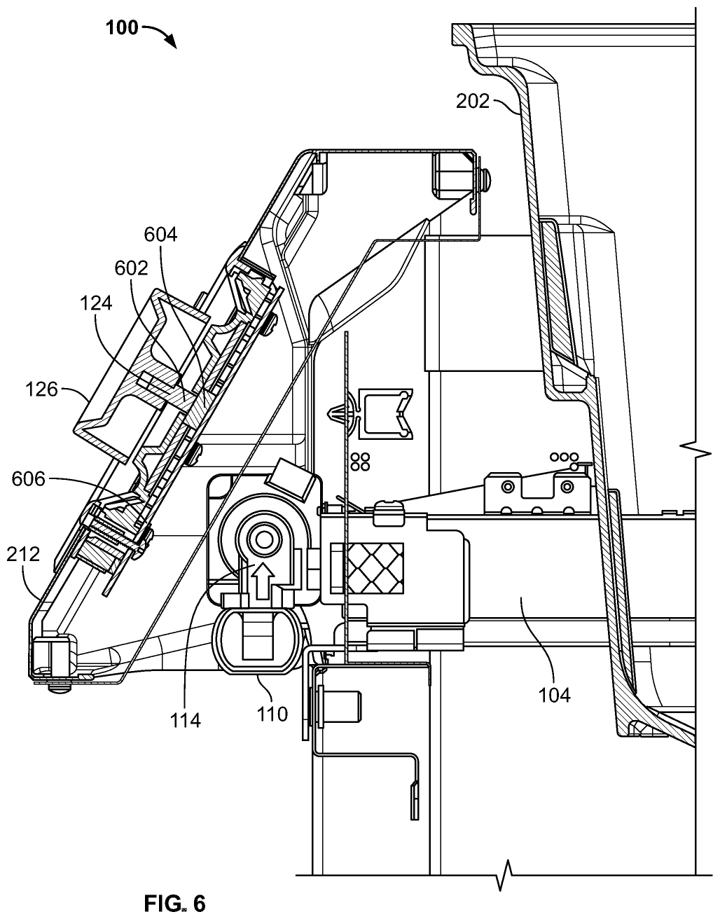

FIG. 6 is a partial cross-sectional view of the implementation of the grill 100 shown in FIGS. 2-4. As shown in FIG. 6, the second encoder 124 of the grill 100 is implemented as a rotary encoder having an example rotatable portion 602 (e.g., a rotatable shaft) to which the second control knob 126 of the grill 100 is mechanically coupled. The rotatable portion 602 of the second encoder 124 can be rotated relative to an example fixed portion 604 of the second encoder 124 via user interaction with the second control knob 126 (e.g., manual rotation of the second control knob 126). The fixed portion 604 of the second encoder 124 includes one or more sensor(s) that is/are configured to sense, measure, and/or detect the relative angular position of the rotatable portion 602 and/or the relative angular position of the second control knob 126. Data, information, and/or signals that is/are sensed, measured, and/or detected by the sensor(s) of the second encoder 124 can be transmitted directly to the controller 144 of FIG. 1, and/or can be transmitted to and stored in the memory 150 of FIG. 1. In some examples, the sensor(s) of the second encoder 124 is/are further configured to sense, measure, and/or detect a translational movement of the rotatable portion 602 relative to the fixed portion 604 of the second encoder 124, as may occur in response to a user of the grill 100 pushing or pressing on the second control knob 126 in a direction that is generally perpendicular to the direction(s) in which the second control knob 126 is configured to be rotated by the user.

In the illustrated example of FIG. 6, the fixed portion 604 of the second encoder 124 of the grill 100 is mounted to an example printed circuit board 606 of the control panel 212 of the grill 100, with the second encoder 124 being located at a position on the control panel 212 that would conventionally be occupied by a stem of a burner valve that corresponds to the second burner valve 114 of the grill 100. Such an example further facilitates locating the second control knob 126 of the grill 100 at a position on or along the control panel 212 that would conventionally be occupied by a control knob that is mechanically coupled to the stem of the burner valve that corresponds to the second burner valve 114 of the grill 100. As further shown in FIG. 6, the second control knob 126 of the grill 100 is not mechanically coupled to the second burner valve 114 of the grill 100. Nor is any portion of the second encoder 124 of the grill 100 mechanically coupled to the second burner valve 114 of the grill 100. Instead, a “control-by-wire” architecture exists in relation to the second control knob 126 of the grill 100 and the second burner valve 114 of the grill 100, with such “control-by-wire” architecture being facilitated via the implementation of the second encoder 124 as described above.

Returning to the illustrated example of FIG. 1, the temperature sensor 128 of FIG. 1 senses, measures, and/or detects the temperature within the cooking chamber 302 of the grill 100. In some examples, the temperature sensor 128 can be implemented by and/or as a thermocouple coupled to either the cookbox 202 or the lid 204 of the grill 100, and positioned in and/or extending into the cooking chamber 302 of the grill 100. Data, information, and/or signals sensed, measured, and/or detected by the temperature sensor 128 of FIG. 1 can be of any quantity, type, form, and/or format. Data, information, and/or signals sensed, measured, and/or detected by the temperature sensor 128 of FIG. 1 can be transmitted directly to the controller 144 of FIG. 1, and/or can be transmitted to and stored in the memory 150 of FIG. 1.

The flame sensor(s) 130 of the grill 100 of FIG. 1 can be implemented by any number(s), any type(s), and/or any configuration(s) of flame sensor(s). The flame sensor(s) 130 is/are configured to sense, measure, and/or detect the presence and/or the absence of a flame emanating from the first burner 102 and/or the second burner 104 of the grill 100. In some examples, one or more of the flame sensor(s) 130 of the grill 100 can be structured, configured, and/or implemented as one of the various flame sensors described in U.S. patent application Ser. No. 17/144,038, filed on Jan. 7, 2021. The entirety of U.S. patent application Ser. No. 17/144,038 is hereby incorporated by reference herein. Data, information, and/or signals sensed, measured, and/or detected by the flame sensor(s) 130 of FIG. 1 can be of any quantity, type, form, and/or format. In some examples, data, information, and/or signals sensed, measured, and/or detected by the flame sensor(s) 130 of FIG. 1 can be transmitted directly to the controller 144 of FIG. 1, and/or can be transmitted to and stored in the memory 150 of FIG. 1.

The lighting module(s) 132 of the grill 100 of FIG. 1 can be implemented by any number(s), any type(s), and/or any configuration(s) of lighting module(s). The lighting module(s) 132 of FIG. 1 is/are configured to project light (e.g., emitted from one or more incandescent, halogen, or light-emitting diode (LED) light source(s) of the lighting module(s) 132) toward or away from one or more structure(s) of the grill 100 including, for example, the cookbox 202, the lid 204, the handle 206, the frame 208, the cabinet 210, the control panel 212, the first side table 214, and/or the second side table 216 of the grill 100. In some examples, one or more of the lighting module(s) 132 is/are mechanically coupled to (e.g., fixedly connected to) the grill 100. For example, one or more of the lighting module(s) 132 can be mounted to the cookbox 202, the lid 204, the handle 206, the frame 208, the cabinet 210, the control panel 212, the first side table 214, and/or the second side table 216 of the grill 100. In such examples, the lighting module(s) 132 is/are preferably mounted to a portion of the grill 100 that enables the light source(s) of the lighting module(s) 132 to be easily viewed by a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100. In some examples, one or more of the lighting module(s) 132 can be implemented by and/or as one or more of the output device(s) 138 of the user interface 134 of the grill 100, as further described below.

One or more of the lighting module(s) 132 of the grill 100 of FIG. 1 can be implemented as a controllable electric lighting module having one or more light source(s) that is/are configured to transition from an off state (e.g., a non-light-projecting state of the light source(s) of the lighting module) to an on state (e.g., a light-projecting state of the light source(s) of the lighting module), and vice-versa, in response to instructions, commands, and/or signals (e.g., a supply of current) generated by the controller 144 of the grill 100. In some examples, one or more of the light source(s) of the lighting module(s) 132 may be instructed, commanded, and/or signaled (e.g., by the controller 144) to illuminate in a manner that causes the light source(s) to appear as being constantly lit (e.g., in a constant light-projecting state) over a duration of time. In other examples, one or more of the light source(s) of the lighting module(s) 132 may be instructed, commanded, and/or signaled (e.g., by the controller 144) to illuminate in a manner that causes the light source(s) to appear as being periodically lit and/or blinking (e.g., switching up and back between a light-projecting state and a non-light-projecting state) over a duration of time. In still other examples, one or more of the light source(s) of the lighting module(s) 132 may be instructed, commanded, and/or signaled (e.g., by the controller 144) to cease illuminating such that the light source(s) appear as being constantly unlit (e.g., in a constant non-light-projecting state) over a duration of time.

In instances where one or more of the light source(s) of the lighting module(s) 132 is/are implemented as an LED, one or more of such LED(s) can be implemented as multi-color LED that can be instructed, commanded, and/or signaled (e.g., by the controller 144) to illuminate in different colors (e.g., white, red, blue, etc.) of the color spectrum. In some such examples, one or more of the multi-color LED(s) may be instructed, commanded, and/or signaled to illuminate in a first color (e.g., white) to indicate that the grill 100 is powered on, and a second color (e.g., red) to indicate that a control knob (e.g., the first control knob 122 or the second control knob 126) of the grill 100 is in a rotational position that corresponds to a burner valve (e.g., the first burner valve 112 or the second burner valve 114) of the grill 100 being in an open position (e.g., a partially-open position or a fully-open position). In some such examples, the intensity of the second color to which the LED(s) is/are illuminated may change in relation to the extent to which the control knob of the grill 100 is rotated, and/or in relation to the extent to which the burner valve of the grill 100 is open. In other such examples, the second color to which the LED(s) is/are illuminated may change to one or more other color(s) (e.g., a third color, a fourth color, etc.) in relation to the extent to which the control knob of the grill 100 is rotated, and/or in relation to the extent to which the burner valve of the grill 100 is open. The aforementioned color schemes are advantageous in that they intuitively informs a user of the grill 100 of the operational status of the burner valve (e.g., the first burner valve 112 or the second burner valve 114) and/or the burner (the first burner 102 or the second burner 104) of the grill 100. In this regard, users of various objects conventionally associate the color red with a warm or hot status of an object, as would exist in a scenario where flames are emanating from a burner of the grill 100.

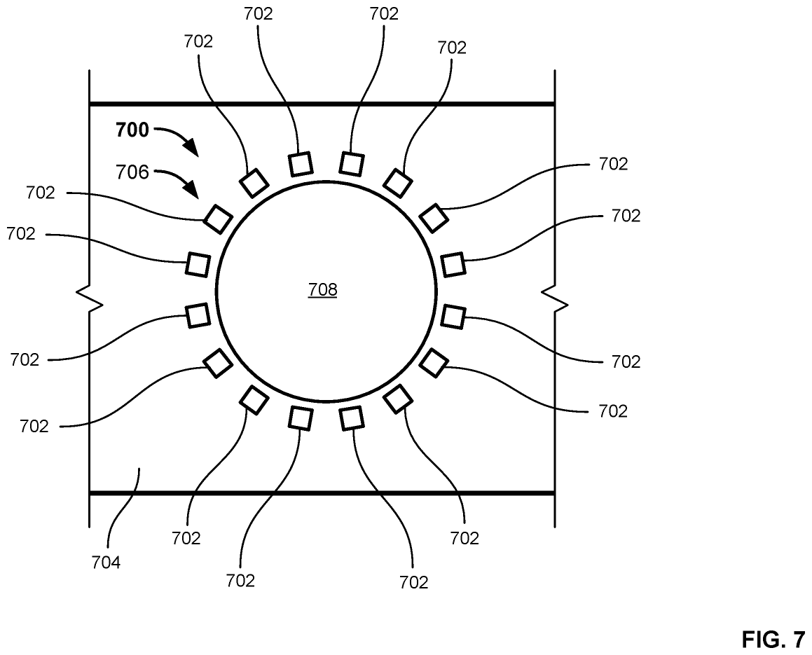

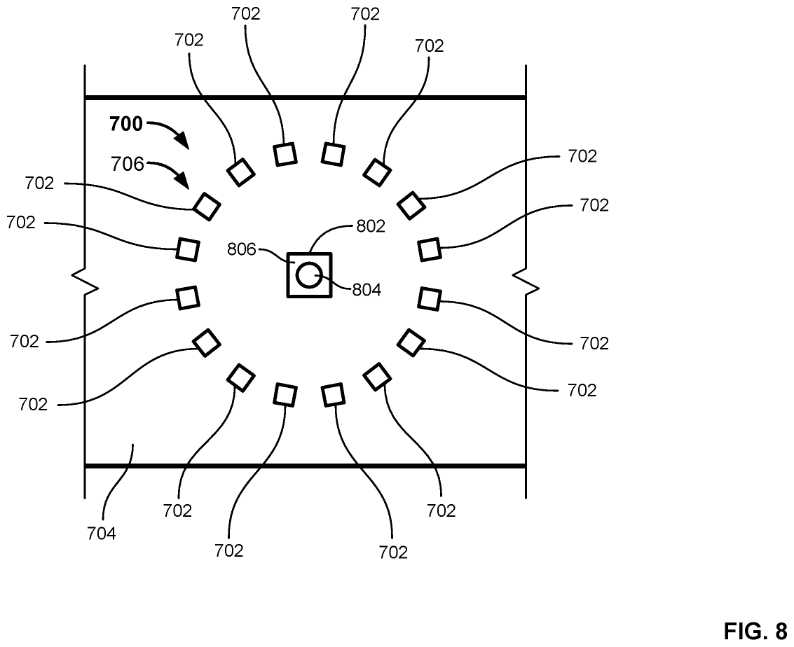

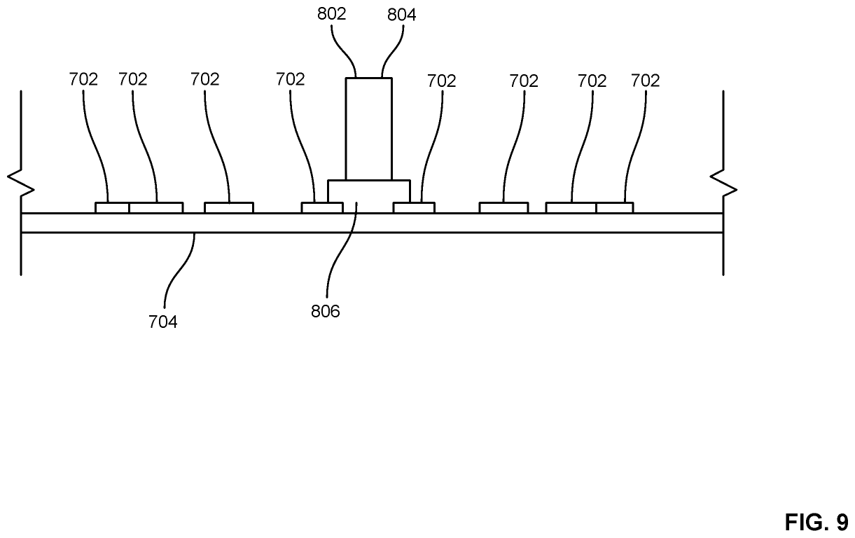

FIG. 7 a front view of an example lighting module 700 that can be implemented by or as one of the lighting module(s) 132 of FIG. 1. In the illustrated example of FIG. 7, the lighting module 700 includes a plurality of example LEDs 702 mounted to, positioned on, and/or otherwise located relative to an example printed circuit board 704 of a control panel of a grill (e.g., the control panel 212 of the grill 100 of FIGS. 2-4 and 6). As shown in FIG. 7, the LEDs 702 are configured as an example ring 706, with the ring 706 being concentrically positioned relative to an example control knob 708 that is also mounted to, positioned on, and/or otherwise located relative to the printed circuit board 704 of the control panel. The control knob 708 of FIG. 7 can be implemented by and or as the first control knob 122 or the second control knob 126 of FIG. 1 described above. FIG. 8 is a front view of the lighting module 700 shown in FIG. 7, with the control knob 708 of FIG. 7 removed. FIG. 9 is a side view of the lighting module 700 shown in FIGS. 7 and 8, with the control knob 708 of FIG. 7 removed.

As shown in FIGS. 8 and 9, the ring 706 of the LEDs 702 is also concentrically positioned relative to an example rotary encoder 802 having an example rotatable portion 804 (e.g., a rotatable shaft) to which the control knob 708 shown in FIG. 7 is mechanically coupled. The rotatable portion 804 of the rotary encoder 802 can be rotated relative to an example fixed portion 806 of the rotary encoder 802 via user interaction with the control knob 708 (e.g., manual rotation of the control knob 708). The fixed portion 806 of the rotary encoder 802 includes one or more sensor(s) that is/are configured to sense, measure, and/or detect the relative angular position of the rotatable portion 804 and/or the relative angular position of the control knob 708. The rotary encoder 802 of FIGS. 8 and 9 can be implemented by or as the first encoder 120 or the second encoder 124 of FIG. 1 described above. Data, information, and/or signals that is/are sensed, measured, and/or detected by the sensor(s) of the rotary encoder 802 can accordingly be transmitted directly to the controller 144 of FIG. 1, and/or can be transmitted to and stored in the memory 150 of FIG. 1.

As shown in FIGS. 8 and 9, the fixed portion 806 of the rotary encoder 802 is mounted to, positioned on, and/or otherwise located relative to the printed circuit board 704 of the control panel. In the illustrated example of FIGS. 7-9, the ring 706 of the LEDs 702 circumscribes the rotary encoder 802 and also circumscribes the control knob 708. In other examples (e.g., when one or more portion(s) of the control knob 708 is/are transparent or translucent), the ring 706 of the LEDs 702 may circumscribe the rotary encoder 802, and the control knob 708 may circumscribe the ring 706 of the LEDs 702.

In the illustrated example of FIGS. 7-9, the LEDs 702 of the lighting module 700 can be either individually or collectively controllable to transition from an off state (e.g., a non-light-projecting state) to an on state (e.g., a light-projecting state) and vice-versa, in response to instructions, commands, and/or signals (e.g., a supply of current) generated by the controller 144 of the grill 100. In this regard, the LEDs 702 can be individually or collectively instructed, commanded, and/or signaled (e.g., by the controller 144) to illuminate in a manner that causes one or more of the LEDs 702 to appear as being constantly lit (e.g., in a constant light-projecting state) over a duration of time. The LEDs 702 can alternatively be individually or collectively instructed, commanded, and/or signaled (e.g., by the controller 144) to illuminate in a manner that causes one or more of the LEDs 702 to appear as being periodically lit and/or blinking (e.g., switching up and back between a light-projecting state and a non-light-projecting state) over a duration of time. The LEDs 702 can alternatively be individually or collectively instructed, commanded, and/or signaled (e.g., by the controller 144) to cease illuminating such that one or more of the LEDs 702 appear(s) as being constantly unlit (e.g., in a constant non-light-projecting state) over a duration of time.

In some examples, the LEDs 702 of the lighting module 700 of FIGS. 7-9 are implemented as multi-color LEDs that can be individually or collectively instructed, commanded, and/or signaled (e.g., by the controller 144) to illuminate in different colors (e.g., white, red, blue, etc.) of the color spectrum. In some such examples, one or more of the multi-color LEDs 702 can be individually or collectively instructed, commanded, and/or signaled to illuminate in a first color (e.g., white) to indicate that the grill 100 is powered on, and a second color (e.g., red) to indicate that the control knob 708 is in a rotational position that corresponds to a burner valve (e.g., the first burner valve 112 or the second burner valve 114) of the grill 100 being in an open position (e.g., a partially-open position or a fully-open position). In some such examples, the intensity of the second color to which the LED(s) 702 is/are illuminated may change in relation to the extent to which the control knob 708 is rotated, and/or in relation to the extent to which the burner valve of the grill 100 is open. In other such examples, the second color to which the LED(s) 702 is/are illuminated may change to one or more other color(s) (e.g., a third color, a fourth color, etc.) in relation to the extent to which the control knob 708 is rotated, and/or in relation to the extent to which the burner valve of the grill 100 is open.

In some examples, respective ones of the LEDs 702 of the lighting module 700 of FIGS. 7-9 can be instructed, commanded, and/or signaled (e.g., by the controller 144) to progressively illuminate in a sequential manner (e.g., moving clockwise or counterclockwise) around the circumference of the ring 706 as the control knob 708 is progressively rotated, and/or as the burner valve that is logically connected to the control knob 708 is progressively opened (e.g., moved from a fully-closed position toward a fully-open position). In some such examples, all of the LEDs 702 of the lighting module 700 of FIG. 7-9 may be in a non-light-projecting state (or, alternatively in a light-projecting state in which the LEDs 702 are illuminated the color white) when the control knob 708 is in a first relative rotational position (e.g., a zero degree position) that corresponds to the burner valve which is logically connected to the control knob 708 being in a fully-closed position (e.g., 0% open position). In such an example, rotation of the control knob 708 in a clockwise direction to a second relative rotational position (e.g., a ninety degree position) may cause the burner valve to be instructed, commanded, and signaled (e.g., by the controller 144) to a first partially-open position (e.g., a 10% open position), and/or may cause several (e.g., between one and four) sequentially-arranged ones of the LEDs 702 to be instructed, commanded, and/or signaled (e.g., by the controller 144) to progressively illuminate (e.g., in a specific color, such as red).

Continuing with such an example, further rotation of the control knob 708 in the clockwise direction to a third relative rotational position (e.g., a one hundred and eighty degree position) may cause the burner valve to be instructed, commanded, and signaled (e.g., by the controller 144) to a second partially-open position (e.g., a 50% open position), and/or may cause several (e.g., between five and eight) sequentially-arranged ones of the LEDs 702 to be instructed, commanded, and/or signaled (e.g., by the controller 144) to progressively illuminate (e.g., in a specific color, such as red). Still further rotation of the control knob 708 in the clockwise direction to a fourth relative rotational position (e.g., a two hundred and seventy degree position) may cause the burner valve to be instructed, commanded, and signaled (e.g., by the controller 144) to a fully-open position (e.g., a 100% open position), and/or may cause several (e.g., between twelve and sixteen) sequentially-arranged ones of the LEDs 702 to be instructed, commanded, and/or signaled (e.g., by the controller 144) to progressively illuminate (e.g., in a specific color, such as red).

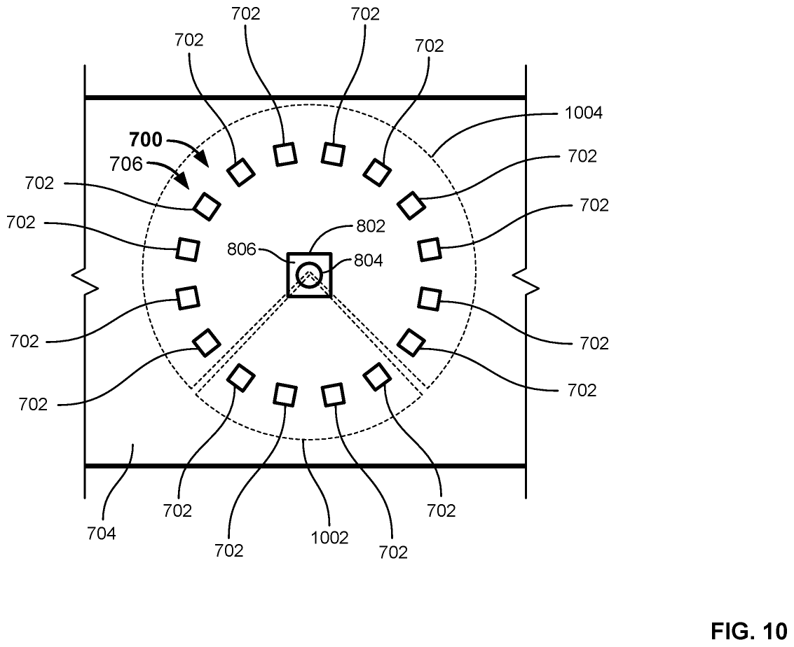

FIG. 10 is another front view of the lighting module shown in FIGS. 7-9, with the control knob of FIG. 7 removed for clarity. As shown in FIG. 10, the ring 706 of the LEDs 702 is partitioned into an example first sector 1002 that forms a first portion of the circumference of the ring 706, and an example second sector 1004 that forms a second portion of the circumference of the ring 706. In the illustrated example of FIG. 10, the first sector 1002 and the second sector 1004 are arranged in a non-overlapping manner, with the second sector 1004 being circumferentially complementary to the first sector 1002. In the illustrated example of FIG. 10, the first sector 1002 includes a lower four of the illustrated total of sixteen ones of the LEDs 702, and the second sector 1004 includes the remaining twelve of the illustrated sixteen ones of the LEDs 702. In other examples, the first sector 1002 and/or the second sector 1004 may respectively include a different number of the LEDs 702 relative to the example described above and shown in FIG. 10.

In the illustrated example of FIG. 10, the LEDs 702 included in the first sector 1002 are reserved for being illuminated one or more color(s) to indicate an operational status of the grill 100 (e.g., that the grill 100 is powered on, that the grill 100 is in manual mode, that the grill 100 is in a controlled cooking mode associated with executing a cook program, etc.). In contrast to the LEDs 702 that are included in the first sector 1002, the LEDs 702 that are located in the second sector 1004 are reserved for being illuminated to indicate the extent to which the control knob 708 is rotated, and/or to indicate the extent to which the burner valve of the grill 100 is open.

In some examples, respective ones of the LEDs 702 included in the second sector 1004 of the lighting module 700 of FIG. 10 can be instructed, commanded, and/or signaled (e.g., by the controller 144) to progressively illuminate in a sequential manner (e.g., moving clockwise or counterclockwise) around the circumference of the ring 706 as the control knob 708 is progressively rotated, and/or as the burner valve that is logically connected to the control knob 708 is progressively opened (e.g., moved from a fully-closed position toward a fully-open position). In some such examples, all of the LEDs 702 included in the second sector 1004 of the lighting module 700 of FIG. 10 may be in a non-light-projecting state (or, alternatively in a light-projecting state in which the LEDs 702 are illuminated the color white) when the control knob 708 is in a first relative rotational position (e.g., a zero degree position) that corresponds to the burner valve which is logically connected to the control knob 708 being in a fully-closed position (e.g., 0% open position). In such an example, rotation of the control knob 708 in a clockwise direction to a second relative rotational position (e.g., a ninety degree position) may cause the burner valve to be instructed, commanded, and signaled (e.g., by the controller 144) to a first partially-open position (e.g., a 10% open position), and/or may cause several (e.g., between one and three) sequentially-arranged ones of the LEDs 702 included in the second sector 1004 to be instructed, commanded, and/or signaled (e.g., by the controller 144) to progressively illuminate (e.g., in a specific color, such as red).

Continuing with such an example, further rotation of the control knob 708 in the clockwise direction to a third relative rotational position (e.g., a one hundred and eighty degree position) may cause the burner valve to be instructed, commanded, and signaled (e.g., by the controller 144) to a second partially-open position (e.g., a 50% open position), and/or may cause several (e.g., between four and six) sequentially-arranged ones of the LEDs 702 included in the second sector 1004 to be instructed, commanded, and/or signaled (e.g., by the controller 144) to progressively illuminate (e.g., in a specific color, such as red). Still further rotation of the control knob 708 in the clockwise direction to a fourth relative rotational position (e.g., a two hundred and seventy degree position) may cause the burner valve to be instructed, commanded, and signaled (e.g., by the controller 144) to a fully-open position (e.g., a 100% open position), and/or may cause several (e.g., between nine and twelve) sequentially-arranged ones of the LEDs 702 included in the second sector 1004 to be instructed, commanded, and/or signaled (e.g., by the controller 144) to progressively illuminate (e.g., in a specific color, such as red).

Returning to the illustrated example of FIG. 1, the user interface 134 of FIG. 1 includes one or more input device(s) 136 (e.g., buttons, dials, knobs, switches, touchscreens, etc.) and/or one or more output device(s) 138 (e.g., liquid crystal displays, light emitting diodes, speakers, etc.) that enable a user of the grill 100 to interact with the above-described control system of the grill 100. In some examples, the output device(s) 138 of the user interface 134 can include one or more of the lighting module(s) 132 described above. The output device(s) 138 of the user interface 134 can be configured to present one or more notification(s) textually (e.g., as a written notification, message, or alert), graphically (e.g., as an illustrated or viewable notification, message, or alert), and/or audibly (e.g., as an audible notification, message, or alert). For example, the output device(s) 138 of the user interface 134 can be configured to textually (e.g., as a written notification, message, or alert), graphically (e.g., as an illustrated or viewable notification, message, or alert), and/or audibly (e.g., as an audible notification, message, or alert) inform the user of the grill 100 that a control knob (e.g., the first control knob 122 or the second control knob 126) or an encoder (e.g., the first encoder 120 or the second encoder 124) of the grill 100 is/are in a specific rotational position. As another example, the output device(s) 138 of the user interface 134 can be configured to textually (e.g., as a written notification, message, or alert), graphically (e.g., as an illustrated or viewable notification, message, or alert), and/or audibly (e.g., as an audible notification, message, or alert) inform the user of the grill 100 that a burner valve (e.g., the first burner valve 112 or the second burner valve 114) of the grill 100 is in a specific operational position (e.g., a fully-closed position, a partially-open position, a fully-open position, etc.).

In the illustrated example of FIG. 1, the user interface 134 is operatively coupled to (e.g., in electrical communication with) the controller 144 and/or the memory 150 of the grill 100. In some examples, the user interface 134 is mechanically coupled to (e.g., fixedly connected to) the grill 100. For example, the user interface 134 can be mounted to the cookbox 202, the lid 204, the handle 206, the frame 208, the cabinet 210, the control panel 212, the first side table 214, and/or the second side table 216 of the grill 100. The user interface 134 is preferably mounted to a portion of the grill 100 that is readily accessible to a user of the grill 100, such as a front portion of the cookbox 202, a front portion of the lid 204, a front portion of the handle 206, a front portion of the frame 208, a front portion of the cabinet 210, a front portion of the control panel 212, a front portion of the first side table 214, and/or a front portion of the second side table 216 of the grill 100.

In some examples, respective ones of the input device(s) 136 and/or the output device(s) 138 of the user interface 134 can be mounted to different portions of the grill 100. For example, a first one of the input device(s) 136 can be mounted to a side portion of either the cookbox 202, the lid 204, the handle 206, the frame 208, the cabinet 210, the control panel 212, the first side table 214, or the second side table 216 of the grill 100, and a second one of the input device(s) 136 can be mounted to a front portion of either the cookbox 202, the lid 204, the handle 206, the frame 208, the cabinet 210, the control panel 212, the first side table 214, or the second side table 216 of the grill 100. The architecture and/or operations of the user interface 134 can be distributed among any number of user interfaces respectively having any number of input device(s) 136 and/or output device(s) 138 located at and/or mounted to any portion of the grill 100.

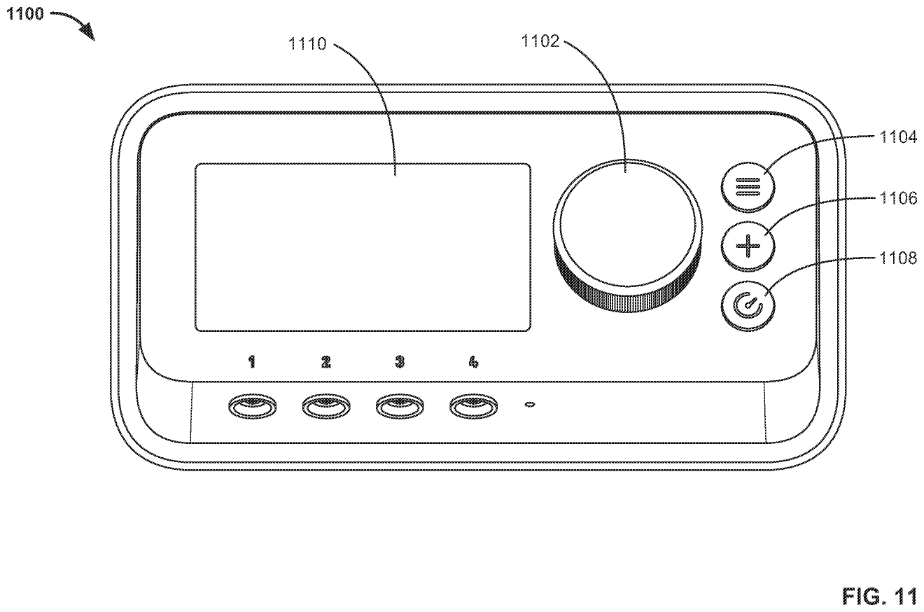

FIG. 11 a front view of an example user interface 1100 that can be implemented by or as the user interface 134 of the grill 100 of FIG. 1. As shown in FIG. 11, the user interface 1100 includes an example dial 1102, an example first button 1104, an example second button 1106, and an example third button 1108 that can be implemented by or as the input device(s) 136 of the user interface 134 of FIG. 1, and an example display 1110 that can be implemented by or as the output device(s) 138 of the user interface 134 of FIG. 1. In the illustrated example of FIG. 11, the dial 1102 of the user interface 1100 is a selection dial that can be rotated by a user of the grill 100 to adjust temperatures of the grill 100, and/or to navigate through options presented on the display 1110 of the user interface 1100. In addition to being rotatable, the dial 1102 can also be pushed by a user of the grill 100 to make and/or confirm a selection of one of the options presented on the display 1110. The first button 1104 of the user interface 1100 is a menu button that can be pressed by a user of the grill 100 to access a main menu (e.g., a “home” menu) of selectable options, and to cause the main menu to be presented on the display 1110 of the user interface 1100. The second button 1106 of the user interface 1100 is a cook program button that can be pressed by a user of the grill 100 to access a library of selectable cook programs, and to cause steps, instructions, operations, notifications, and/or alerts associated with the selectable cook programs to be presented on the display 1110 of the user interface 1100. The third button 1108 of the user interface 1100 is a timer button that can be pressed by a user of the grill 100 to initiate a timer, and to cause the running time associated with the timer to be presented on the display 1110 of the user interface 1100. The display 1110 of the user interface 1100 is a liquid crystal display configured to present textual and/or graphical information to a user of the grill 100. In some examples, the display 1110 can be implemented as a touch screen, in which case the display 1110 can be implemented not only as one of the output device(s) 138 of the user interface 134, but also as another one of the input device(s) 136 of the user interface 134.

In some examples, one or more notification(s) presented via the display 1110 of the user interface 800 may inform the user of the grill 100 of a specific rotational position associated with a control knob (e.g., the first control knob 122 or the second control knob 126) or an encoder (e.g., the first encoder 120 or the second encoder 124) of the grill 100, or of a specific operational position associated with a burner valve (e.g., the first burner valve 112 or the second burner valve 114) of the grill 100. For example, the display 1110 of the user interface 1100 may textually (e.g., as a written notification, message, or alert), graphically (e.g., as an illustrated or viewable notification, message, or alert), and/or audibly (e.g., as an audible notification, message, or alert) inform the user of the grill 100 that a control knob (e.g., the first control knob 122 or the second control knob 126) or an encoder (e.g., the first encoder 120 or the second encoder 124) of the grill 100 is/are in a specific rotational position. As another example, the display 1110 of the user interface 1100 may textually (e.g., as a written notification, message, or alert), graphically (e.g., as an illustrated or viewable notification, message, or alert), and/or audibly (e.g., as an audible notification, message, or alert) inform the user of the grill 100 that a burner valve (e.g., the first burner valve 112 or the second burner valve 114) of the grill 100 is in a specific operational position.

The network interface 140 of FIG. 1 includes one or more communication device(s) 142 (e.g., transmitter(s), receiver(s), transceiver(s), modem(s), gateway(s), wireless access point(s), etc.) to facilitate exchange of data with external machines (e.g., computing devices of any kind, including the remote device(s) 152 of FIG. 1) by a wired or wireless communication network. Communications transmitted and/or received via the communication device(s) 142 and/or, more generally, via the network interface 140 can be made over and/or carried by, for example, an Ethernet connection, a digital subscriber line (DSL) connection, a telephone line connection, a coaxial cable system, a satellite system, a wireless system, a cellular telephone system, an optical connection, etc. The network interface 140 enables a user of the grill 100 to remotely interact (e.g., via one or more of the remote device(s) 152) with the above-described control system of the grill 100. In the illustrated example of FIG. 1, the network interface 140 is operatively coupled to (e.g., in electrical communication with) the controller 144 and/or the memory 150 of the grill 100.

The remote device(s) 152 of FIG. 1 can be implemented by any type(s) and/or any number(s) of mobile or stationary computing devices. In this regard, examples of such remote device(s) 152 include a smartphone, a tablet, a laptop, a desktop, a cloud server, a wearable computing device, etc. The remote device(s) 152 of FIG. 1 facilitate a remote (e.g., wired, or wireless) extension of the above-described user interface 134 of the grill 100. In this regard, each remote device 152 includes one or more input device(s) and/or one or more output device(s) that mimic and/or enable a remotely-located version of the above-described functionality of the corresponding input device(s) 136 and/or the corresponding output device(s) 138 of the user interface 134 of the grill 100. Accordingly, one or more notification(s) transmitted from the grill 100 (e.g., via the communication device(s) 142 of the network interface 140 of the grill 100) can be presented via the output device(s) of the remote device(s) 152 much in the same way that such notification(s) would be presented via the output device(s) 138 of the user interface 134 of the grill 100.

The controller 144 of FIG. 1 manages and/or controls the control system of the grill 100 and/or the components thereof. In the illustrated example of FIG. 1, the controller 144 is operatively coupled to (e.g., in electrical communication with) the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 150 of the grill 100 of FIG. 1. The controller 144 of FIG. 1 is also operatively coupled to (e.g., in wired or wireless electrical communication with) the remote device(s) 152 of FIG. 1 via the network interface 140 (e.g., including the communication device(s) 142) of the grill 100 of FIG. 1. In the illustrated example of FIG. 1, the controller 144 includes the control circuitry 146 and the detection circuitry 148 of FIG. 1, each of which is discussed in further detail herein. The control circuitry 146, the detection circuitry 148, and/or, more generally, the controller 144 of FIG. 1 can individually and/or collectively be implemented by any type(s) and/or any number(s) of semiconductor device(s) (e.g., processor(s), microprocessor(s), microcontroller(s), etc.) and/or circuit(s).

In the illustrated example of FIG. 1, the controller 144 is graphically represented as a single, discrete structure that manages and/or controls the operation(s) of various components of the control system of the grill 100. It is to be understood, however, that in other examples, the architecture and/or operations of the controller 144 can be distributed among any number of controllers, with each separate controller having a dedicated subset of one or more operation(s) described herein. As but one example, the controller 144 of FIG. 1 can be separated into two distinct controllers, whereby a first one of the two controllers includes the control circuitry 146 of the controller 144, and a second one of the two controllers includes the detection circuitry 148 of the controller 144. In some examples, the grill 100 can further include separate, distinct controllers for one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), and/or the memory 150 of the grill 100 of FIG. 1.

The controller 144 of FIG. 1 manages and/or controls the implementation and/or execution of one or more process(es), protocol(s), program(s), sequence(s), and/or method(s) associated with controlling the flow of gas through the first burner valve 112 and/or the second burner valve 114 of the grill 100 of FIG. 1 based on position data detected via the first encoder 120 and/or the second encoder 124 of the grill 100 of FIG. 1. In some examples, the controller 144 of FIG. 1 additionally or alternatively manages and/or controls the implementation and/or execution of one or more process(es), protocol(s), program(s), sequence(s), and/or method(s) associated with causing one or more of the lighting module(s) 132 of the grill 100 of FIG. 1 to present one or more notification(s) indicating the rotational position(s) of the first control knob 122 and/or the second control knob 126 of the grill 100 of FIG. 1, and/or to present one or more notification(s) indicating the target position(s) of the first burner valve 112 and/or the second burner valve 114 of the grill 100 of FIG. 1. In some examples, the controller 144 of FIG. 1 additionally or alternatively manages and/or controls the implementation and/or execution of one or more process(es), protocol(s), program(s), sequence(s), and/or method(s) associated with causing one or more of the output device(s) 138 of the user interface 134 of the grill 100 of FIG. 1 to present one or more notification(s) indicating the rotational position(s) of the first control knob 122 and/or the second control knob 126 of the grill 100 of FIG. 1, and/or to present one or more notification(s) indicating the target position(s) of the first burner valve 112 and/or the second burner valve 114 of the grill 100 of FIG. 1. In some examples, the controller 144 of FIG. 1 additionally or alternatively manages and/or controls the implementation and/or execution of one or more process(es), protocol(s), program(s), sequence(s), and/or method(s) associated with causing one or more notification(s) indicating the rotational position(s) of the first control knob 122 and/or the second control knob 126 of the grill 100 of FIG. 1, and/or one or more notification(s) indicating the target position(s) of the first burner valve 112 and/or the second burner valve 114 of the grill 100 of FIG. 1, to be presented at one or more of the remote device(s) 152 of FIG. 1 that is/are in electrical communication with the grill 100 of FIG. 1.

The control circuitry 146 of the controller 144 of FIG. 1 manages and/or controls one or more operation(s) of one or more controllable component(s) of the grill 100 that is/are operatively coupled to (e.g., in electrical communication with) the controller 144 of the grill 100. For example, the control circuitry 146 may include valve control circuitry configured to instruct, command, signal, and/or otherwise cause the fuel source valve 108, the first burner valve 112, and/or the second burner valve 114 of the grill 100 to open (e.g., fully open), to close (e.g., fully close), or to otherwise change position. The control circuitry 146 may additionally or alternatively include ignitor control circuitry configured to instruct, command, signal, and/or otherwise cause the first ignitor 116 and/or the second ignitor 118 of the grill 100 to ignite corresponding ones of the first burner 102 and/or the second burner 104 of the grill 100. The control circuitry 146 may additionally or alternatively include lighting control circuitry configured to instruct, command, signal, and/or otherwise cause one or more light source(s) of one or more of the lighting module(s) 132 of the grill 100 to transition (e.g., once, or repeatedly) from an off state (e.g., a non-light-projecting state) to an on state (e.g., a light-projecting state), or vice-versa. In some examples, the transitioning of the one or more light source(s) of one or more of the lighting module(s) 132 from the off state to the on state, or vice-versa, effects the presentation of one or more notification(s) (e.g., one or more visible message(s) or alert(s)).

The control circuitry 146 may additionally or alternatively include user interface control circuitry configured to instruct, command, signal, and/or otherwise cause one or more of the output device(s) 138 of the user interface 134 of the grill 100 to textually, graphically, or audibly present data and/or information, which may include one or more notification(s) (e.g., one or more visible, audible, and/or tactile message(s) or alert(s)). The control circuitry 146 may additionally or alternatively include network interface control circuitry configured to instruct, command, signal, and/or otherwise cause one or more of the communication device(s) 142 of the network interface 140 of the grill 100 to transmit data and/or information, which may include one or more notification(s) (e.g., one or more visible, audible, and/or tactile message(s) or alert(s)) to one or more of the remote device(s) 152 of FIG. 1.

The detection circuitry 148 of the controller 144 of FIG. 1 detects and/or determines one or more state(s), condition(s), operation(s), and/or event(s) associated with the grill 100 based on data, information, and/or signals received from one or more component(s) of the grill 100 that is/are operatively coupled to (e.g., in wired or wireless electrical communication with) the controller 144 of the grill 100. For example, the detection circuitry 148 may include valve detection circuitry configured to detect and/or determine a relative position of the fuel source valve 108, the first burner valve 112, and/or the second burner valve 114 of the grill 100 based on one or more instruction(s), command(s), and/or signal(s) generated at the control circuitry 146 of the controller 144 and/or transmitted to the fuel source valve 108, the first burner valve 112, and/or the second burner valve 114.

The detection circuitry 148 may additionally or alternatively include encoder detection circuitry configured to detect and/or determine a relative position (e.g., a relative rotational position) of the first control knob 122 and/or the second control knob 126 of the grill 100 based on data, information, and/or signals received from corresponding ones of the first encoder 120 and/or the second encoder 124 of the grill 100. The detection circuitry 148 may additionally or alternatively include temperature detection circuitry configured to detect and/or determine one or more temperature state(s), condition(s), operation(s), and/or event(s) associated with the grill 100 (e.g., that a temperature of the cooking chamber 302 of the grill 100 is either above or below a predetermined temperature threshold) based on data, information, and/or signals received from the temperature sensor 128 of the grill 100. The detection circuitry 148 may additionally or alternatively include flame detection circuitry configured to detect and/or determine the presence or the absence of a flame at the first burner 102 and/or the second burner 104 of the grill 100 based on data, information, and/or signals received from one or more of the flame sensor(s) 130 of the grill 100.

The detection circuitry 148 may additionally or alternatively include user interface detection circuitry configured to detect and/or determine one or more user interface state(s), condition(s), operation(s), and/or event(s) associated with the grill 100 (e.g., that a user has interacted with one or more of the input device(s) 136 of the user interface 134, that a user has failed to interact with one or more of the input device(s) 136 of the user interface 134, etc.) based on data, information, and/or signals received from the user interface 134 of the grill 100. The detection circuitry 148 may additionally or alternatively include network interface detection circuitry configured to detect and/or determine one or more network interface state(s), condition(s), operation(s), and/or event(s) associated with the grill 100 (e.g., that one or more of the communication device(s) 142 of the network interface 140 has received data, information, and/or signals indicating that a user has interacted with one or more input device(s) of one or more of the remote device(s) 152, that one or more of the communication device(s) 142 of the network interface 140 has failed to receive data, information, and/or signals indicating that a user has interacted with one or more input device(s) of one or more of the remote device(s) 152, etc.) based on data, information, and/or signals received from the network interface 140 of the grill 100.

In some examples, the controller 144 of the grill 100 of FIG. 1 is configured to implement a gas flow control process. In some examples, the detection circuitry 148 of the controller 144 of FIG. 1 is configured to determine a rotational position of a control knob (e.g., the first control knob 122 or the second control knob 126 of FIG. 1) of the grill 100 of FIG. 1 based on position data sensed, measured, and/or detected (e.g., continuously, or periodically) via a rotary encoder (e.g., the first encoder 120 or the second encoder 124 of FIG. 1) of the grill 100 to which the control knob is mechanically coupled. In some examples, the detection circuitry 148 of the controller 144 is further configured to determine a target position of a burner valve (e.g., the first burner valve 112 or the second burner valve 114 of FIG. 1) of the grill 100 based on the rotational position of the control knob of the grill 100. For example, the detection circuitry 148 of the controller 144 may be configured to determine the target position of the burner valve of the grill 100 by accessing a correlation table (e.g., as may be stored in the memory 150 of the grill 100) that establishes and/or defines one or more correlation(s) and/or relationship(s) between one or more position(s) (e.g., one or more rotational position(s)) of the rotary encoder and/or the control knob of the grill 100 of FIG. 1 on the one hand, and one or more position(s) (e.g., one or more target position(s)) of the burner valve of the grill 100 of FIG. 1 on the other hand (e.g., the target position of the burner valve is Y percent open when the relative rotational position of the control knob is X degrees). In some examples, the control circuitry 146 of the controller 144 of FIG. 1 is configured to instruct, command, signal, and/or otherwise cause the burner valve (e.g., the first burner valve 112 or the second burner valve 114 of FIG. 1) of the grill 100 of FIG. 1 to move to the target position of the burner valve.

In some examples, the controller 144 of the grill 100 of FIG. 1 is configured to implement a control knob position notification process. In some examples, the detection circuitry 148 of the controller 144 of FIG. 1 is configured to determine a rotational position of a control knob (e.g., the first control knob 122 or the second control knob 126 of FIG. 1) of the grill 100 of FIG. 1 based on position data sensed, measured, and/or detected (e.g., continuously, or periodically) via a rotary encoder (e.g., the first encoder 120 or the second encoder 124 of FIG. 1) of the grill 100 to which the control knob is mechanically coupled. In some examples, the control circuitry 146 of the controller 144 of FIG. 1 is configured to generate one or more notification(s) (e.g., visible, audible, and/or tactile message(s) or alert(s)) indicating the rotational position of the control knob of the grill 100 of FIG. 1.

In some examples, the control circuitry 146 of the controller 144 of FIG. 1 is configured to instruct, command, signal, and/or otherwise cause the notification(s) indicating the rotational position of the control knob of the grill 100 of FIG. 1 to be presented locally and/or remotely. For example, the control circuitry 146 may be configured to instruct, command, signal, and/or otherwise cause one or more of the lighting module(s) 132 of the grill 100 of FIG. 1 to locally present one or more of the notification(s) indicating the rotational position of the control knob of the grill 100. The control circuitry 146 may additionally or alternatively be configured to instruct, command, signal, and/or otherwise cause the user interface 134 of the grill 100 of FIG. 1 to locally present (e.g., via one or more of the output device(s) 138 of the user interface 134) one or more of the notification(s) indicating the rotational position of the control knob of the grill 100. The control circuitry 146 may additionally or alternatively be configured to instruct, command, signal, and/or otherwise cause the network interface 140 of the grill 100 of FIG. 1 to transmit (e.g., via one or more of the communication device(s) 142 of the network interface 140) one or more of the notification(s) indicating the rotational position of the control knob of the grill 100 to one or more of the remote device(s) 152 of FIG. 1 for remote presentation via one or more of the output device(s) of the remote device(s) 152. In some examples, one or more of the notification(s) indicating the rotational position of the control knob of the grill 100 may be presented for a predetermined duration (e.g., a predetermined presentation duration, as may be stored in the memory 150 of the grill 100). In other examples, one or more of the notification(s) indicating the rotational position of the control knob of the grill 100 may be presented until a countering event (e.g., determining that the rotational position of the control knob of the grill 100 has changed, receiving a request, command, and/or instruction to terminate the presentation of the notification(s), etc.) occurs.

In some examples, the controller 144 of the grill 100 of FIG. 1 is configured to implement a burner valve position notification process. In some examples, the detection circuitry 148 of the controller 144 of FIG. 1 is configured to determine a position (e.g., a current operational position) of a burner valve (e.g., the first burner valve 112 or the second burner valve 114 of FIG. 1) of the grill 100 of FIG. 1. For example, the detection circuitry 148 may be configured to determine the position of the burner valve of the grill 100 based on one or more instruction(s), command(s), and/or signal(s) previously generated at the control circuitry 146 of the controller 144 and/or previously transmitted to the burner valve of the grill 100. The control circuitry 146 of the controller 144 of FIG. 1 is configured to generate one or more notification(s) (e.g., visible, audible, and/or tactile message(s) or alert(s)) indicating the position of the burner valve of the grill 100 of FIG. 1.

In some examples, the control circuitry 146 of the controller 144 of FIG. 1 is configured to instruct, command, signal, and/or otherwise cause the notification(s) indicating the position of the burner valve of the grill 100 of FIG. 1 to be presented locally and/or remotely. For example, the control circuitry 146 may be configured to instruct, command, signal, and/or otherwise cause one or more of the lighting module(s) 132 of the grill 100 of FIG. 1 to locally present one or more of the notification(s) indicating the position of the burner valve of the grill 100. The control circuitry 146 may additionally or alternatively be configured to instruct, command, signal, and/or otherwise cause the user interface 134 of the grill 100 of FIG. 1 to locally present (e.g., via one or more of the output device(s) 138 of the user interface 134) one or more of the notification(s) indicating the position of the burner valve of the grill 100. The control circuitry 146 may additionally or alternatively be configured to instruct, command, signal, and/or otherwise cause the network interface 140 of the grill 100 of FIG. 1 to transmit (e.g., via one or more of the communication device(s) 142 of the network interface 140) one or more of the notification(s) indicating the position of the burner valve of the grill 100 to one or more of the remote device(s) 152 of FIG. 1 for remote presentation via one or more of the output device(s) of the remote device(s) 152. In some examples, one or more of the notification(s) indicating the position of the burner valve of the grill 100 may be presented for a predetermined duration (e.g., a predetermined presentation duration, as may be stored in the memory 150 of the grill 100). In other examples, one or more of the notification(s) indicating the position of the burner valve of the grill 100 may be presented until a countering event (e.g., determining that the position of the burner valve of the grill 100 has changed, receiving a request, command, and/or instruction to terminate the presentation of the notification(s), etc.) occurs.

The memory 150 of FIG. 1 can be implemented by any type(s) and/or any number(s) of storage device(s) such as a storage drive, a flash memory, a read-only memory (ROM), a random-access memory (RAM), a cache and/or any other physical storage medium in which information is stored for any duration (e.g., for extended time periods, permanently, brief instances, for temporarily buffering, and/or for caching of the information). The information stored in the memory 150 of FIG. 1 can be stored in any file and/or data structure format, organization scheme, and/or arrangement.

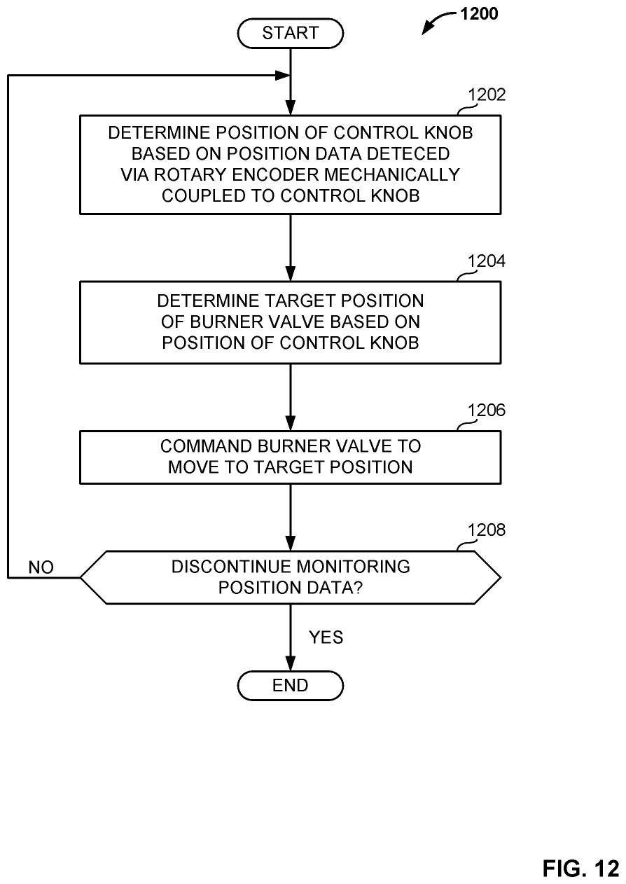

The memory 150 stores data sensed, measured, detected, generated, accessed, input, output, transmitted, and/or received by, to, and/or from the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146 and the detection circuitry 148), the remote device(s) 152, and/or, more generally, the control system of the grill 100 of FIG. 1. The memory 150 also stores instructions (e.g., machine-readable instructions) and associated data (e.g., correlation data including, for example, one or more correlation table(s), etc.) corresponding to the processes, protocols, programs, sequences, and/or methods described below in connection with FIGS. 12-14. The memory 150 of FIG. 1 is accessible to one or more of the fuel source valve 108, the first burner valve 112, the second burner valve 114, the first ignitor 116, the second ignitor 118, the first encoder 120, the second encoder 124, the temperature sensor 128, the flame sensor(s) 130, the lighting module(s) 132, the user interface 134 (e.g., including the input device(s) 136 and the output device(s) 138), the network interface 140 (e.g., including the communication device(s) 142), the controller 144 (e.g., including the control circuitry 146 and the detection circuitry 148), the remote device(s) 152, and/or, more generally, the control system of the grill 100 of FIG. 1.

While an example manner of implementing the control system of the grill 100 is illustrated in FIG. 1, one or more of the elements, processes, and/or devices illustrated in FIG. 1 may be combined, divided, re-arranged, omitted, eliminated, and/or implemented in any other way. Further, the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146 and the example detection circuitry 148), the example memory 150, and/or, more generally, the control system of the grill 100 of FIG. 1, may be implemented by hardware alone or by hardware in combination with software and/or firmware. Thus, for example, any of the example fuel source valve 108, the example first burner valve 112, the example second burner valve 114, the example first ignitor 116, the example second ignitor 118, the example first encoder 120, the example second encoder 124, the example temperature sensor 128, the example flame sensor(s) 130, the example lighting module(s) 132, the example user interface 134 (e.g., including the example input device(s) 136 and the example output device(s) 138), the example network interface 140 (e.g., including the example communication device(s) 142), the example controller 144 (e.g., including the example control circuitry 146 and the example detection circuitry 148), the example memory 150, and/or, more generally, the control system of the grill 100 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control system of the grill of FIG. 1 may include one or more elements, processes, and/or devices in addition to, or instead of, those illustrated in FIG. 1, and/or may include more than one of any or all of the illustrated elements, processes, and devices.

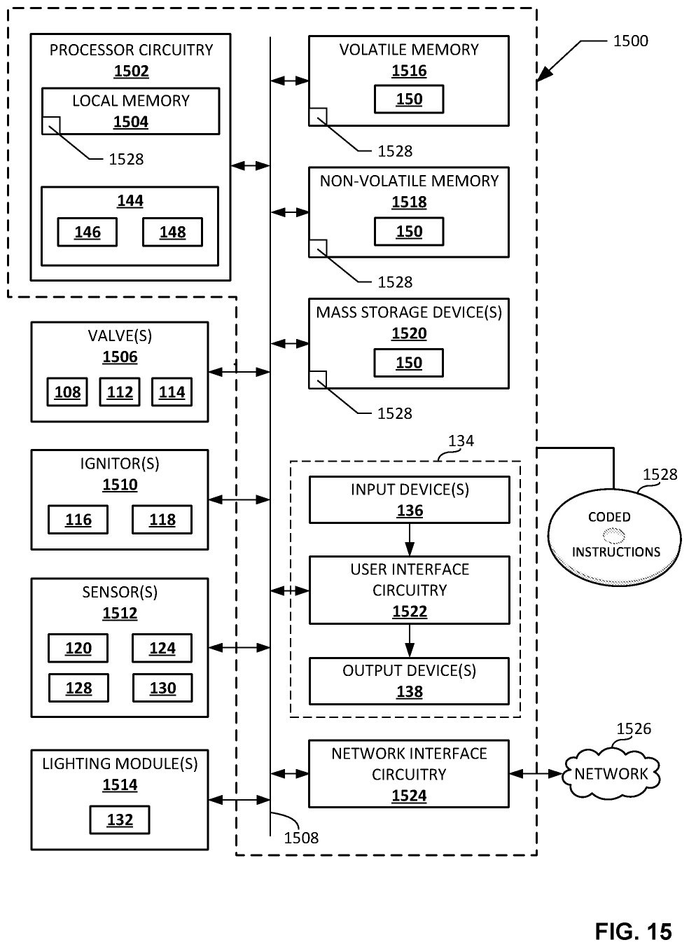

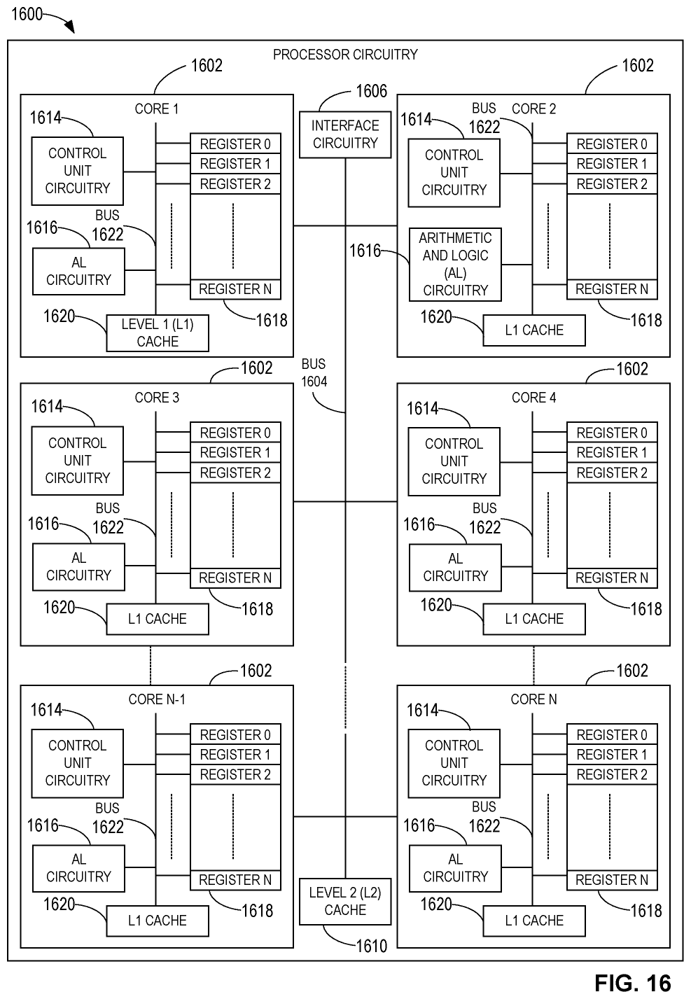

Flowcharts representing example hardware logic circuitry, machine-readable instructions, hardware implemented state machines, and/or any combination thereof for implementing the grill 100 of FIG. 1 are shown in FIGS. 12-14. The machine-readable instructions may be one or more executable program(s) or portion(s) thereof for execution by processor circuitry, such as the processor circuitry 1502 shown in the example processor platform 1500 discussed below in connection with FIG. 15 and/or the example processor circuitry discussed below in connection with FIGS. 16 and/or 17. The program(s) may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program(s) and/or the portion(s) thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although example programs are described with reference to the flowcharts illustrated in FIGS. 12-14, many other methods of implementing the example grill 100 may alternatively be used. For example, the order of execution of the blocks may be changed, and/or some of the blocks described may be changed, eliminated, or combined. Additionally, or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12-14 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable medium” and “non-transitory computer-readable storage medium” are expressly defined to include any type of computer-readable storage device and/or storage disk and to exclude propagating signals and to exclude transmission media.

The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine-readable instructions and/or example operations 1200 that may be executed by processor circuitry to implement a gas flow control process of the grill 100 of FIG. 1. The machine-readable instructions and/or operations 1200 of FIG. 12 begin at block 1202 when the detection circuitry 148 of the controller 144 of FIG. 1 determines and/or detects a rotational position of a control knob (e.g., the first control knob 122 or the second control knob 126 of FIG. 1) of the grill 100 of FIG. 1 based on position data sensed, measured, and/or detected (e.g., continuously, or periodically) via a rotary encoder (e.g., the first encoder 120 or the second encoder 124 of FIG. 1) of the grill 100 to which the control knob is mechanically coupled. Following block 1202, control of the example machine-readable instructions and/or operations 1200 of FIG. 12 proceeds to block 1204.

At block 1204, the detection circuitry 148 of the controller 144 of FIG. 1 determines a target position of a burner valve (e.g., the first burner valve 112 or the second burner valve 114 of FIG. 1) of the grill 100 of FIG. 1 based on the rotational position of the control knob of the grill 100. For example, the detection circuitry 148 may determine the target position of the burner valve of the grill 100 by accessing a correlation table (e.g., as may be stored in the memory 150 of the grill 100) that establishes and/or defines one or more correlation(s) and/or relationship(s) between one or more position(s) (e.g., one or more rotational position(s)) of the rotary encoder and/or the control knob of the grill 100 of FIG. 1 on the one hand, and one or more position(s) (e.g., one or more target position(s)) of the burner valve of the grill 100 of FIG. 1 on the other hand (e.g., the target position of the burner valve is Y percent open when the relative rotational position of the control knob is X degrees). Following block 1204, control of the example machine-readable instructions and/or operations 1200 of FIG. 12 proceeds to block 1206.

At block 1206, the control circuitry 146 of the controller 144 of FIG. 1 instructs, commands, signals, and/or otherwise causes the burner valve (e.g., the first burner valve 112 or the second burner valve 114 of FIG. 1) of the grill 100 of FIG. 1 to move to the target position of the burner valve. Following block 1206, control of the machine-readable instructions and/or operations 1200 of FIG. 12 proceeds to block 1208.

At block 1208 the controller 144 of FIG. 1 determines whether to discontinue monitoring position data associated with the rotational position of the control knob (e.g., the first control knob 122 or the second control knob 126 of FIG. 1) and/or the rotational position of the rotary encoder (e.g., the first encoder 120 or the second encoder 124 of FIG. 1) of the grill 100 of FIG. 1. For example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 152 of FIG. 1, as received and/or detected via the network interface 140 of FIG. 1. If the controller 144 determines at block 1208 that the monitoring of the position data is to be continued, control of the machine-readable instructions and/or operations 1200 of FIG. 12 returns to block 1202. If the controller 144 instead determines at block 1208 that the monitoring of the position data is to be discontinued, the machine-readable instructions and/or operations 1200 of FIG. 12 end.

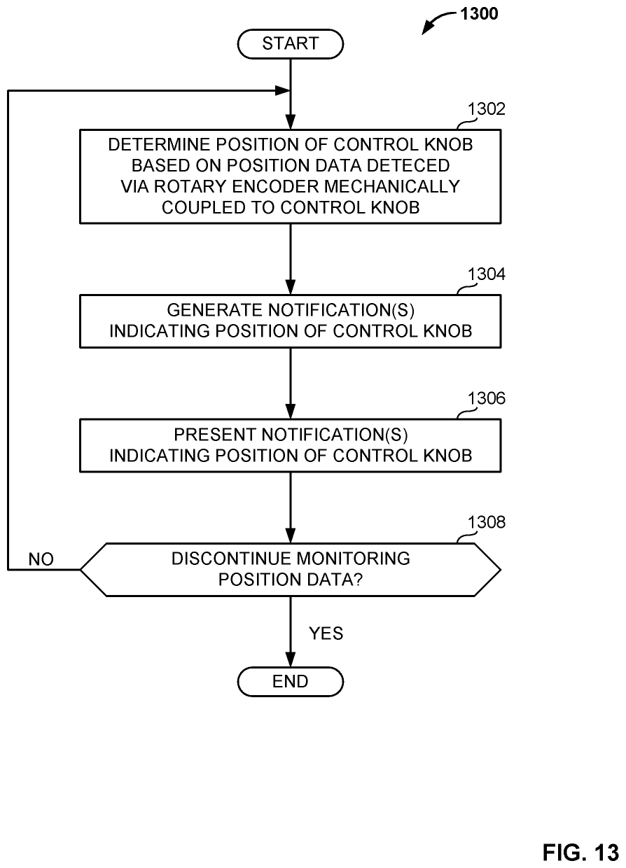

FIG. 13 is a flowchart representative of example machine-readable instructions and/or example operations 1300 that may be executed by processor circuitry to implement a control knob position notification process of the grill 100 of FIG. 1. The machine-readable instructions and/or operations 1300 of FIG. 13 begin at block 1302 when the detection circuitry 148 of the controller 144 of FIG. 1 determines and/or detects a rotational position of a control knob (e.g., the first control knob 122 or the second control knob 126 of FIG. 1) of the grill 100 of FIG. 1 based on position data sensed, measured, and/or detected (e.g., continuously, or periodically) via a rotary encoder (e.g., the first encoder 120 or the second encoder 124 of FIG. 1) of the grill 100 to which the control knob is mechanically coupled. Following block 1302, control of the example machine-readable instructions and/or operations 1300 of FIG. 13 proceeds to block 1304.

At block 1304, the control circuitry 146 of the controller 144 of FIG. 1 generates one or more notification(s) (e.g., visible, audible, and/or tactile message(s) or alert(s)) indicating the rotational position of the control knob of the grill 100 of FIG. 1. In some examples, the control circuitry 146 generates one or more notification(s) that, when presented, is/are intended to expressly inform a user of the grill 100 of the rotational position of the control knob of the grill 100. In other examples, the control circuitry 146 generates one or more notification(s) that, when presented, is/are intended to inherently and/or intuitively inform a user of the grill 100 of the rotational position of the control knob of the grill 100. Following block 1304, control of the example machine-readable instructions and/or operations 1300 of FIG. 13 proceeds to block 1306.

At block 1306, the control circuitry 146 of the controller 144 of FIG. 1 instructs, commands, signals, and/or otherwise causes the notification(s) indicating the rotational position of the control knob of the grill 100 of FIG. 1 to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating the rotational position of the control knob of the grill 100. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating the rotational position of the control knob of the grill 100. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating the rotational position of the control knob of the grill 100 to one or more of the remote device(s) 152 of FIG. 1 for remote presentation via one or more of the output device(s) of the remote device(s) 152. In some examples, one or more of the notification(s) indicating the rotational position of the control knob of the grill 100 may be presented for a predetermined duration (e.g., a predetermined presentation duration, as may be stored in the memory 150 of the grill 100). In other examples, one or more of the notification(s) indicating the rotational position of the control knob of the grill 100 may be presented until a countering event (e.g., determining that the rotational position of the control knob of the grill 100 has changed, receiving a request, command, and/or instruction to terminate the presentation of the notification(s), etc.) occurs. Following block 1306, control of the example machine-readable instructions and/or operations 1300 of FIG. 13 proceeds to block 1308.

At block 1308 the controller 144 of FIG. 1 determines whether to discontinue monitoring position data associated with the rotational position of the control knob (e.g., the first control knob 122 or the second control knob 126 of FIG. 1) and/or the rotational position of the rotary encoder (e.g., the first encoder 120 or the second encoder 124 of FIG. 1) of the grill 100 of FIG. 1. For example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 152 of FIG. 1, as received and/or detected via the network interface 140 of FIG. 1. If the controller 144 determines at block 1308 that the monitoring of the position data is to be continued, control of the machine-readable instructions and/or operations 1300 of FIG. 13 returns to block 1302. If the controller 144 instead determines at block 1308 that the monitoring of the position data is to be discontinued, the machine-readable instructions and/or operations 1300 of FIG. 13 end.

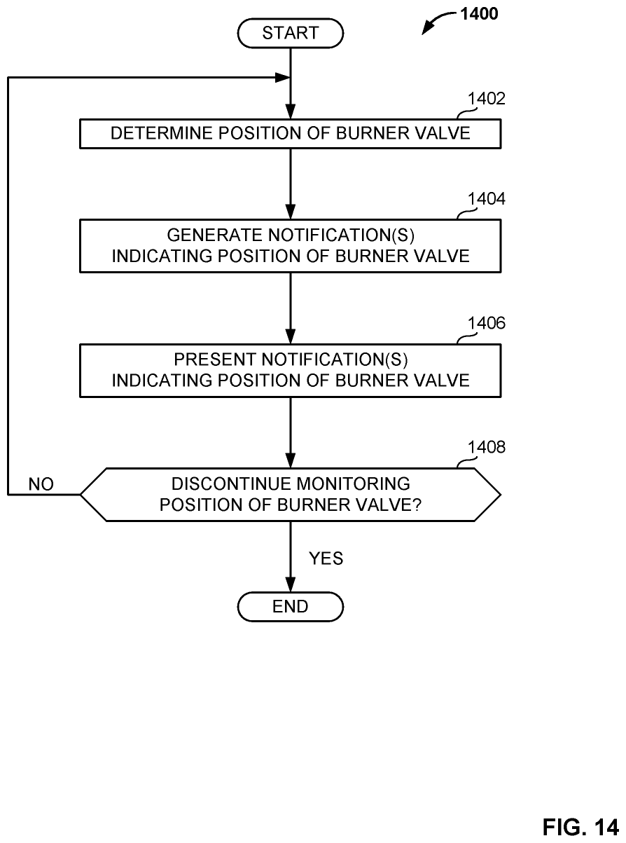

FIG. 14 is a flowchart representative of example machine-readable instructions and/or example operations 1300 that may be executed by processor circuitry to implement a burner valve position notification process of the grill 100 of FIG. 1. The machine-readable instructions and/or operations 1400 of FIG. 14 begin at block 1402 when the detection circuitry 148 of the controller 144 of FIG. 1 determines a position (e.g., a current operational position) of a burner valve (e.g., the first burner valve 112 or the second burner valve 114 of FIG. 1) of the grill 100 of FIG. 1. For example, the detection circuitry 148 may determine the position of the burner valve of the grill 100 based on one or more instruction(s), command(s), and/or signal(s) previously generated at the control circuitry 146 of the controller 144 and/or previously transmitted to the burner valve of the grill 100. Following block 1402, control of the example machine-readable instructions and/or operations 1400 of FIG. 14 proceeds to block 1404.

At block 1404, the control circuitry 146 of the controller 144 of FIG. 1 generates one or more notification(s) (e.g., visible, audible, and/or tactile message(s) or alert(s)) indicating the position of the burner valve of the grill 100 of FIG. 1. In some examples, the control circuitry 146 generates one or more notification(s) that, when presented, is/are intended to expressly inform a user of the grill 100 of the position of the burner valve of the grill 100. In other examples, the control circuitry 146 generates one or more notification(s) that, when presented, is/are intended to inherently and/or intuitively inform a user of the grill 100 of the position of the burner valve of the grill 100. Following block 1404, control of the example machine-readable instructions and/or operations 1400 of FIG. 14 proceeds to block 1406.

At block 1406, the control circuitry 146 of the controller 144 of FIG. 1 instructs, commands, signals, and/or otherwise causes the notification(s) indicating the position of the burner valve of the grill 100 of FIG. 1 to be presented locally and/or remotely. For example, the control circuitry 146 may instruct, command, signal, and/or otherwise cause one or more of the lighting module(s) 132 of the grill 100 of FIG. 1 to locally present one or more of the notification(s) indicating the position of the burner valve of the grill 100. As another example, the control circuitry 146 may additionally or alternatively instruct, command, signal, and/or otherwise cause the user interface 134 of the grill 100 of FIG. 1 to locally present (e.g., via one or more of the output device(s) 138 of the user interface 134) one or more of the notification(s) indicating the position of the burner valve of the grill 100. As yet another example, the control circuitry 146 may additionally or alternatively instruct, command, signal, and/or otherwise cause the network interface 140 of the grill 100 of FIG. 1 to transmit (e.g., via one or more of the communication device(s) 142 of the network interface 140) one or more of the notification(s) indicating the position of the burner valve of the grill 100 to one or more of the remote device(s) 152 of FIG. 1 for remote presentation via one or more of the output device(s) of the remote device(s) 152. In some examples, one or more of the notification(s) indicating the position of the burner valve of the grill 100 may be presented for a predetermined duration (e.g., a predetermined presentation duration, as may be stored in the memory 150 of the grill 100). In other examples, one or more of the notification(s) indicating the position of the burner valve of the grill 100 may be presented until a countering event (e.g., determining that the position of the burner valve of the grill 100 has changed, receiving a request, command, and/or instruction to terminate the presentation of the notification(s), etc.) occurs. Following block 1406, control of the example machine-readable instructions and/or operations 1400 of FIG. 14 proceeds to block 1408.

At block 1408 the controller 144 of FIG. 1 determines whether to discontinue monitoring position data associated with the position of the burner valve (e.g., the first burner valve 112 or the second burner valve 114 of FIG. 1) of the grill 100 of FIG. 1. For example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more of the input device(s) 136 (e.g., a button, a dial, a knob, a switch, a touchscreen, etc.) of the user interface 134 of FIG. 1. As another example, the controller 144 may determine that a request, command, and/or instruction to discontinue monitoring such position data has been received based on a user input, a user selection, and/or a user interaction (e.g., a press, a push, a pull, a rotation, a click, a flip, a swipe, a touch, etc.) of, to, and/or with one or more input device(s) (e.g., a button, a dial, a knob, a switch, a touchscreen, etc.) of one of the remote device(s) 152 of FIG. 1, as received and/or detected via the network interface 140 of FIG. 1. If the controller 144 determines at block 1408 that the monitoring of the position data is to be continued, control of the machine-readable instructions and/or operations 1400 of FIG. 14 returns to block 1402. If the controller 144 instead determines at block 1408 that the monitoring of the position data is to be discontinued, the machine-readable instructions and/or operations 1400 of FIG. 14 end.

FIG. 15 is a block diagram of an example processor platform 1500 including processor circuitry structured to execute and/or instantiate the machine-readable instructions and/or operations of FIGS. 12-14 to implement the grill 100 of FIG. 1. The processor platform 1500 of the illustrated example includes processor circuitry 1502. The processor circuitry 1502 of the illustrated example is hardware. For example, the processor circuitry 1502 can be implemented by one or more integrated circuit(s), logic circuit(s), FPGA(s), microprocessor(s), CPU(s), GPU(s), DSP(s), and/or microcontroller(s) from any desired family or manufacturer. The processor circuitry 1502 may be implemented by one or more semiconductor based (e.g., silicon based) device(s). In this example, the processor circuitry 1502 implements the controller 144 of FIG. 1, including the control circuitry 146 and the detection circuitry 148 of the controller 144.

The processor circuitry 1502 of the illustrated example includes a local memory 1504 (e.g., a cache, registers, etc.). The processor circuitry 1502 is in electrical communication with one or more valve(s) 1506 via a bus 1508. In this example, the valve(s) 1506 include the fuel source valve 108, the first burner valve 112, and the second burner valve 114 of FIG. 1. The processor circuitry 1502 is also in electrical communication with one or more ignitor(s) 1510 via the bus 1508. In this example, the ignitor(s) 1510 include the first ignitor 116 and the second ignitor 118 of FIG. 1. The processor circuitry 1502 is also in electrical communication with one or more sensor(s) 1512 via the bus 1508. In this example, the sensor(s) 1512 include the first encoder 120, the second encoder 124, the temperature sensor 128, and the flame sensor(s) 130 of FIG. 1. The processor circuitry 1502 is also in electrical communication with one or more lighting module(s) 1514 via the bus 1508. In this example, the lighting module(s) 1514 include the lighting module(s) 132 of FIG. 1.

The processor circuitry 1502 is also in electrical communication with a main memory via the bus 1508, with the main memory including a volatile memory 1516 and a non-volatile memory 1518. The volatile memory 1516 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1518 may be implemented by flash memory and/or any other desired type of memory device. Access to the main memory 1516, 1518 of the illustrated example is controlled by a memory controller.

The processor platform 1500 of the illustrated example also includes one or more mass storage device(s) 1520 to store software and/or data. Examples of such mass storage device(s) 1520 include magnetic storage devices, optical storage devices, floppy disk drives, HDDs, CDs, Blu-ray disk drives, redundant array of independent disks (RAID) systems, solid state storage devices such as flash memory devices, and DVD drives. In the illustrated example of FIG. 15, one or more of the volatile memory 1516, the non-volatile memory 1518, and/or the mass storage device(s) 1520 implement(s) the memory 150 of FIG. 1.

The processor platform 1500 of the illustrated example also includes user interface circuitry 1522. The user interface circuitry 1522 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 136 are connected to the user interface circuitry 1522. The input device(s) 136 permit(s) a user to enter data and/or commands into the processor circuitry 1502. The input device(s) 136 can be implemented by, for example, one or more button(s), dial(s), knob(s), switch(es), touchscreen(s), audio sensor(s), microphone(s), image sensor(s), and/or camera(s). One or more output device(s) 138 are also connected to the user interface circuitry 1522 of the illustrated example. The output device(s) 138 can be implemented, for example, by one or more display device(s) (e.g., light emitting diode(s) (LED(s)), organic light emitting diode(s) (OLED(s)), liquid crystal display(s) (LCD(s)), cathode ray tube (CRT) display(s), in-place switching (IPS) display(s), touchscreen(s), etc.), tactile output device(s), and/or speaker(s). The user interface circuitry 1522 of the illustrated example, thus, typically includes a graphics driver card, a graphics driver chip, and/or graphics processor circuitry such as a GPU. In the illustrated example of FIG. 15, the user interface circuitry 1522, the input device(s) 136, and the output device(s) 138 collectively implement the user interface 134 of FIG. 1.

The processor platform 1500 of the illustrated example also includes network interface circuitry 1524. The network interface circuitry 1524 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 152 of FIG. 1) by a network 1526. The communication can be by, for example, an Ethernet connection, a digital subscriber line (DSL) connection, a telephone line connection, a coaxial cable system, a satellite system, a wireless system, a cellular telephone system, an optical connection, etc. In the illustrated example of FIG. 15, the network interface circuitry 1524 implements the network interface 140 (e.g., including the communication device(s) 142) of FIG. 1.

Coded instructions 1528 including the above-described machine-readable instructions and/or operations of FIGS. 12-14 may be stored the local memory 1504, in the volatile memory 1516, in the non-volatile memory 1518, on the mass storage device(s) 1520, and/or on a removable non-transitory computer-readable storage medium such as a flash memory stick, a dongle, a CD, or a DVD.

FIG. 16 is a block diagram of an example implementation of the processor circuitry 1502 of FIG. 15. In this example, the processor circuitry 1502 of FIG. 15 is implemented by a microprocessor 1600. For example, the microprocessor 1600 may implement multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine-readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine-readable instructions and/or operations represented by the flowcharts of FIGS. 12-14.

The cores 1602 may communicate by an example bus 1604. In some examples, the bus 1604 may implement a communication bus to effectuate communication associated with one(s) of the cores 1602. For example, the bus 1604 may implement at least one of an Inter-Integrated Circuit (I2C) bus, a Serial Peripheral Interface (SPI) bus, a PCI bus, or a PCIe bus. Additionally, or alternatively, the bus 1604 may implement any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2_cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1516, 1518 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the L1 cache 1620, and an example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating point operations. In yet other examples, the AL circuitry 1616 may include first AL circuitry that performs integer based operations and second AL circuitry that performs floating point operations. In some examples, the AL circuitry 1616 may be referred to as an Arithmetic Logic Unit (ALU). The registers 1618 are semiconductor-based structures to store data and/or instructions such as results of one or more of the operations performed by the AL circuitry 1616 of the corresponding core 1602. For example, the registers 1618 may include vector register(s), SIMD register(s), general purpose register(s), flag register(s), segment register(s), machine specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure including distributed throughout the core 1602 to shorten access time. The bus 1622 may implement at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 1600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

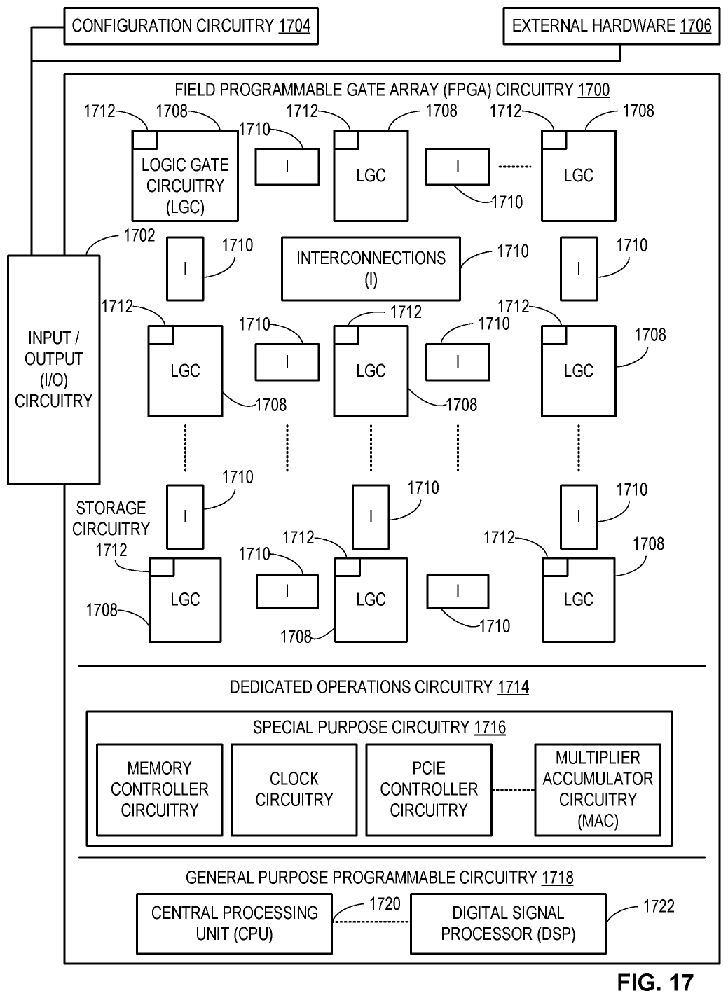

FIG. 17 is a block diagram of another example implementation of the processor circuitry 1502 of FIG. 15. In this example, the processor circuitry 1502 is implemented by FPGA circuitry 1700. The FPGA circuitry 1700 can be used, for example, to perform operations that could otherwise be performed by the example microprocessor 1600 of FIG. 16 executing corresponding machine-readable instructions. However, once configured, the FPGA circuitry 1700 instantiates the machine-readable instructions in hardware and, thus, can often execute the operations faster than they could be performed by a general purpose microprocessor executing the corresponding software.

More specifically, in contrast to the microprocessor 1600 of FIG. 16 described above (which is a general purpose device that may be programmed to execute some or all of the machine-readable instructions and/or operations represented by the flowcharts of FIGS. 12-14, but whose interconnections and logic circuitry are fixed once fabricated), the FPGA circuitry 1700 of the example of FIG. 17 includes interconnections and logic circuitry that may be configured and/or interconnected in different ways after fabrication to instantiate, for example, some or all of the machine-readable instructions and/or operations represented by the flowcharts of FIGS. 12-14. In particular, the FPGA circuitry 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the software represented by the flowcharts of FIGS. 12-14. As such, the FPGA circuitry 1700 may be structured to effectively instantiate some or all of the machine-readable instructions of the flowcharts of FIGS. 12-14 as dedicated logic circuits to perform the operations corresponding to those software instructions in a dedicated manner analogous to an ASIC. Therefore, the FPGA circuitry 1700 may perform the operations corresponding to the some or all of the machine-readable instructions of FIGS. 12-14 faster than the general purpose microprocessor can execute the same.

In the example of FIG. 17, the FPGA circuitry 1700 is structured to be programmed (and/or reprogrammed one or more times) by an end user by a hardware description language (HDL) such as Verilog. The FPGA circuitry 1700 of FIG. 17 includes example input/output (I/O) circuitry 1702 to obtain and/or output data to/from example configuration circuitry 1704 and/or external hardware (e.g., external hardware circuitry) 1706. For example, the configuration circuitry 1704 may implement interface circuitry that may obtain machine-readable instructions to configure the FPGA circuitry 1700, or portion(s) thereof. In some such examples, the configuration circuitry 1704 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 1706 may implement the microprocessor 1600 of FIG. 16. The FPGA circuitry 1700 also includes an array of example logic gate circuitry 1708, a plurality of example configurable interconnections 1710, and example storage circuitry 1712. The logic gate circuitry 1708 and interconnections 1710 are configurable to instantiate one or more operations that may correspond to at least some of the machine-readable instructions of FIGS. 12-14 and/or other desired operations. The logic gate circuitry 1708 shown in FIG. 17 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations. The logic gate circuitry 1708 may include other electrical structures such as look-up tables (LUTs), registers (e.g., flip-flops or latches), multiplexers, etc.

The interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example Dedicated Operations Circuitry 1714. In this example, the Dedicated Operations Circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the processor circuitry 1502 of FIG. 15, many other approaches are contemplated. For example, as mentioned above, modern FPGA circuitry may include an on-board CPU, such as one or more of the example CPU 1720 of FIG. 17. Therefore, the processor circuitry 1502 of FIG. 15 may additionally be implemented by combining the example microprocessor 1600 of FIG. 16 and the example FPGA circuitry 1700 of FIG. 17. In some such hybrid examples, a first portion of the machine-readable instructions and/or operations represented by the flowcharts of FIGS. 12-14 may be executed by one or more of the cores 1602 of FIG. 16 and a second portion of the machine-readable instructions and/or operations represented by the flowcharts of FIGS. 12-14 may be executed by the FPGA circuitry 1700 of FIG. 17.

In some examples, the processor circuitry 1502 of FIG. 15 may be in one or more packages. For example, the microprocessor 1600 of FIG. 16 and/or the FPGA circuitry 1700 of FIG. 17 may be in one or more packages. In some examples, an XPU may be implemented by the processor circuitry 1502 of FIG. 15, which may be in one or more packages. For example, the XPU may include a CPU in one package, a DSP in another package, a GPU in yet another package, and an FPGA in still yet another package.

From the foregoing, it will be appreciated that the above-disclosed methods and apparatus advantageously provide “control-by-wire” architectures for gas grills that eliminate the mechanical connection which conventionally exists between each control knob of the grill and each corresponding burner valve of the grill. In some examples, the above-described “control-by-wire” architectures can be implemented in part by a rotary encoder configured to detect a rotational position of a control knob to which the rotary encoder is mechanically coupled. In other examples, another type of rotational position sensor may be implemented in lieu of such a rotary encoder. For example, any of the above-described “control-by-wire” architectures can alternatively be implemented in part by a rotary Hall effect sensor, a rotary potentiometer, a rotary inductive position sensor, a rotary variable differential transformer, or some other form of a rotational position sensor configured to detect a rotational position of a control knob to which the rotational position sensor is mechanically coupled. Like the rotary encoder implementations described above, any of the aforementioned alternate rotational position sensors can be implemented in a manner such that the rotational position sensor is mechanically coupled to the control knob of the grill, but not mechanically coupled to the corresponding burner valve of the grill.

In still other examples, one or more input device(s) of a user interface of the grill can be implemented in lieu of the above-described rotational position sensor(s). For example, a controller of the grill in electrical communication with a burner valve of the grill may be configured to instruct, command, signal, and/or otherwise cause the burner valve to move to a target position based on an input received via the input device(s) of the user interface. In still other examples, one or more input device(s) of a remote device in electrical communication with the grill can be implemented in lieu of the above-described rotational position sensor(s). For example, a controller of the grill in electrical communication with a burner valve of the grill may be configured to instruct, command, signal, and/or otherwise cause the burner valve to move to a target position based on an input provided via the input device(s) of the remote device. In still other examples, one or more instruction(s), command(s), and/or signal(s) associated with one or more automated cook program(s) executed at the grill can be implemented in lieu of the above-described rotational position sense(s). For example, a controller of the grill in electrical communication with a burner valve of the grill may be configured to instruct, command, signal, and/or otherwise cause the burner valve to move to a target position based on an instruction, a command, and/or a signal generated pursuant to an automated cook program being executed at the grill.

In some examples, a grill is disclosed. In some disclosed examples, the grill comprises a burner valve, a control knob, a rotary encoder, and a controller. In some disclosed examples, the burner valve is movable between an open position and a closed position. In some disclosed examples, the rotary encoder includes a rotatable portion and a fixed portion. In some disclosed examples, the control knob is mechanically coupled to the rotatable portion. In some disclosed examples, the rotatable portion is rotatable relative to the fixed portion. In some disclosed examples, the rotary encoder is to detect a rotational position of the control knob. In some disclosed examples, the rotational position of the control knob corresponds to a rotational position of the rotatable portion relative to the fixed portion. In some disclosed examples the controller is in electrical communication with the rotary encoder. In some disclosed examples, the controller is to determine a target position of the burner valve based on the rotational position of the control knob. In some disclosed examples, the controller is to instruct the burner valve to move to the target position.

In some disclosed examples, the control knob is not mechanically coupled to the burner valve.

In some disclosed examples, the controller is to instruct a lighting module of the grill to present a notification indicating the rotational position of the control knob.

In some disclosed examples, the lighting module includes a light source, and presenting the notification includes illuminating the light source.

In some disclosed examples, the lighting module includes a light source, and presenting the notification includes pulsing the light source.

In some disclosed examples, the lighting module includes a plurality of light sources arranged as a ring. In some disclosed examples, the ring is concentrically positioned relative to the control knob.

In some disclosed examples, the ring circumscribes the rotary encoder.

In some disclosed examples, the controller is to instruct a lighting module of the grill to present a notification indicating the target position of the burner valve.

In some disclosed examples, the controller is to instruct one or more output devices of a user interface of the grill to present a notification indicating at least one of the rotational position of the control knob or the target position of the burner valve.

In some disclosed examples, the controller is to instruct a notification indicating at least one of the rotational position of the control knob or the target position of the burner valve to be presented at a remote device in electrical communication with the grill.

In some examples, a method is disclosed. In some disclosed examples, the method comprises detecting a rotational position of a control knob of a grill via a rotary encoder of the grill. In some disclosed examples, the rotary encoder includes a rotatable portion and a fixed portion. In some disclosed examples, the control knob is mechanically coupled to the rotatable portion. In some disclosed examples, the rotatable portion is rotatable relative to the fixed portion. In some disclosed examples, the rotational position of the control knob corresponds to a rotational position of the rotatable portion relative to the fixed portion. In some disclosed examples, the method further comprises determining, via a controller of the grill in electrical communication with the rotary encoder, a target position of a burner valve of the grill based on the rotational position of the control knob. In some disclosed examples, the method further comprises instructing, via the controller, the burner valve to move to the target position.

In some disclosed examples, the control knob is not mechanically coupled to the burner valve.

In some disclosed examples, the method further comprises instructing a lighting module of the grill to present a notification indicating the rotational position of the control knob.

In some disclosed examples, the lighting module includes a light source, and presenting the notification includes illuminating the light source.

In some disclosed examples, the lighting module includes a light source, and presenting the notification includes pulsing the light source.

In some disclosed examples, the lighting module includes a plurality of light sources arranged as a ring. In some disclosed examples, the ring is concentrically positioned relative to the control knob.

In some disclosed examples, the ring circumscribes the rotary encoder.

In some disclosed examples, the method further comprises instructing, via the controller, a lighting module of the grill to present a notification indicating the target position of the burner valve.

In some disclosed examples, the method further comprises instructing, via the controller, one or more output devices of a user interface of the grill to present a notification indicating at least one of the rotational position of the control knob or the target position of the burner valve.

In some disclosed examples, the method further comprises instructing, via the controller, a notification indicating at least one of the rotational position of the control knob or the target position of the burner valve to be presented at a remote device in electrical communication with the grill.

In some examples, a non-transitory computer-readable medium comprising computer-readable instructions is disclosed. In some disclosed examples, the instructions, when executed, cause one or more processors of a grill to determine a rotational position of a control knob of a grill detected via a rotary encoder of the grill. In some disclosed examples, the rotary encoder includes a rotatable portion and a fixed portion. In some disclosed examples, the control knob is mechanically coupled to the rotatable portion. In some disclosed examples, the rotatable portion is rotatable relative to the fixed portion. In some disclosed examples, the rotational position of the control knob corresponds to a rotational position of the rotatable portion relative to the fixed portion. In some disclosed examples, the instructions, when executed, cause the one or more processors to determine a target position of a burner valve of the grill based on the rotational position of the control knob. In some disclosed examples, the instructions, when executed, cause the one or more processors to instruct the burner valve to move to the target position.

In some disclosed examples, the control knob is not mechanically coupled to the burner valve.

In some disclosed examples, the instructions, when executed, cause the one or more processors to instruct a lighting module of the grill to present a notification indicating the rotational position of the control knob.

In some disclosed examples, the lighting module includes a light source, and presenting the notification includes illuminating the light source.

In some disclosed examples, the lighting module includes a light source, and presenting the notification includes pulsing the light source.

In some disclosed examples, the lighting module includes a plurality of light sources arranged as a ring. In some disclosed examples, the ring is concentrically positioned relative to the control knob.

In some disclosed examples, the ring circumscribes the rotary encoder.

In some disclosed examples, the instructions, when executed, cause the one or more processors to instruct a lighting module of the grill to present a notification indicating the target position of the burner valve.

In some disclosed examples, the instructions, when executed, cause the one or more processors to instruct one or more output devices of a user interface of the grill to present a notification indicating at least one of the rotational position of the control knob or the target position of the burner valve.

In some disclosed examples, the instructions, when executed, cause the one or more processors to instruct a notification indicating at least one of the rotational position of the control knob or the target position of the burner valve to be presented at a remote device in electrical communication with the grill.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. A grill, comprising:
a burner valve movable between an open position and a closed position;
a control knob;
a rotary encoder including a rotatable portion and a fixed portion, the control knob mechanically coupled to the rotatable portion, the rotatable portion rotatable relative to the fixed portion, the rotary encoder to detect a rotational position of the control knob, the rotational position of the control knob corresponding to a rotational position of the rotatable portion relative to the fixed portion; and
a controller in electrical communication with the rotary encoder, the controller to:
determine a target position of the burner valve based on the rotational position of the control knob; and
instruct the burner valve to move to the target position.

2. The grill of claim 1, wherein the control knob is not mechanically coupled to the burner valve.

3. The grill of claim 1, wherein the controller is to instruct a lighting module of the grill to present a notification indicating the rotational position of the control knob.

4. The grill of claim 3, wherein the lighting module includes a light source, and presenting the notification includes illuminating the light source.

5. The grill of claim 3, wherein the lighting module includes a light source, and presenting the notification includes pulsing the light source.

6. The grill of claim 3, wherein the lighting module includes a plurality of light sources arranged as a ring, the ring concentrically positioned relative to the control knob.

7. The grill of claim 6, wherein the ring circumscribes the rotary encoder.

8. The grill of claim 1, wherein the controller is to instruct a lighting module of the grill to present a notification indicating the target position of the burner valve.

9. The grill of claim 1, wherein the controller is to instruct one or more output devices of a user interface of the grill to present a notification indicating at least one of the rotational position of the control knob or the target position of the burner valve.

10. The grill of claim 1, wherein the controller is to instruct a notification indicating at least one of the rotational position of the control knob or the target position of the burner valve to be presented at a remote device in electrical communication with the grill.

11. A method, comprising:
detecting a rotational position of a control knob of a grill via a rotary encoder of the grill, the rotary encoder including a rotatable portion and a fixed portion, the control knob mechanically coupled to the rotatable portion, the rotatable portion rotatable relative to the fixed portion, the rotational position of the control knob corresponding to a rotational position of the rotatable portion relative to the fixed portion;
determining, via a controller of the grill in electrical communication with the rotary encoder, a target position of a burner valve of the grill based on the rotational position of the control knob; and
instructing, via the controller, the burner valve to move to the target position.

12. The method of claim 11, wherein the control knob is not mechanically coupled to the burner valve.

13. The method of claim 11, further comprising instructing a lighting module of the grill to present a notification indicating the rotational position of the control knob.

14-15. (canceled)

16. The method of claim 13, wherein the lighting module includes a plurality of light sources arranged as a ring, the ring concentrically positioned relative to the control knob.

17. (canceled)

18. The method of claim 11, further comprising instructing, via the controller, a lighting module of the grill to present a notification indicating the target position of the burner valve.

19. The method of claim 11, further comprising instructing, via the controller, one or more output devices of a user interface of the grill to present a notification indicating at least one of the rotational position of the control knob or the target position of the burner valve.

20. (canceled)

21. A non-transitory computer-readable medium comprising computer-readable instructions that, when executed, cause one or more processors of a grill to at least:
determine a rotational position of a control knob of a grill detected via a rotary encoder of the grill, the rotary encoder including a rotatable portion and a fixed portion, the control knob mechanically coupled to the rotatable portion, the rotatable portion rotatable relative to the fixed portion, the rotational position of the control knob corresponding to a rotational position of the rotatable portion relative to the fixed portion;
determine a target position of a burner valve of the grill based on the rotational position of the control knob; and
instruct the burner valve to move to the target position.

22. The non-transitory computer-readable medium of claim 21, wherein the control knob is not mechanically coupled to the burner valve.

23. The non-transitory computer-readable medium of claim 21, wherein the computer-readable instructions, when executed, cause the one or more processors to instruct a lighting module of the grill to present a notification indicating the rotational position of the control knob.

24-27. (canceled)

28. The non-transitory computer-readable medium of claim 21, wherein the computer-readable instructions, when executed, cause the one or more processors to instruct a lighting module of the grill to present a notification indicating the target position of the burner valve.

29-30. (canceled)
